(19) United States
(12) Patent Application Publication
(10) Pub. No.: US 2026/0046053 A1
(43) Pub. Date: Feb. 12, 2026

(54) COMMUNICATION SYSTEM, FIRST OPTICAL COMMUNICATION APPARATUS AND TRANSMISSION LINE CHARACTERISTIC IDENTIFICATION METHOD

(71) Applicant: NTT, Inc., Tokyo (JP)

(72) Inventors: Manabu YOSHINO, Musashino-shi (JP); Tomoaki YOSHIDA, Musashino-shi (JP); Kazutaka HARA, Musashino-shi (JP); Shin KANEKO, Musashino-shi (JP)

(73) Assignee: NTT, Inc., Tokyo (JP)

(21) Appl. No.: 19/100,429

(22) PCT Filed: Aug. 4, 2022
(86) PCT No.: PCT/JP2022/029932

§ 371 Date: Jan. 31, 2025

(51) Int. Cl. H04J 14/02

(52) U.S. Cl. CPC H04J 14/0227

(57) ABSTRACT

A communication system includes: one or more first optical communication devices; a second optical communication device that communicates with the one or more first optical communication devices; and a transmission path that connects the one or more first optical communication devices and the second optical communication device. The one or more first optical communication devices include: a transmitting unit that transmits an optical signal having a wavelength within a wavelength range for confirmation transmission characteristics in the optical transmission path to the second optical communication device via the optical transmission path. The communication system includes a specifying unit that specifies the transmission characteristics in the optical transmission path based on an optical signal having a wavelength within the wavelength range transmitted from the one or more first optical communication devices.

### DESCRIPTION

### Technical Field

The present invention relates to a communication system, a first optical communication device, and a transmission path characteristics specifying method.

### Background Art

With the spread of IoT (Internet of Things) and the progress of digitalization of society and industry, the amount of data flowing on the Internet is increasing. Additionally, service use cases of a type different from the best-effort type are emerging. For the enhancement of such services, demands for guaranteed bandwidth and low latency are increasing for communication networks. For example, in a cyber-physical system, transport infrastructure is required to upload a huge amount of sensing data obtained from the real world (physical space) to the information processing platform (cyber space) in real time without loss, feed control information to the real world with high reliability and low latency, and transmit high-definition images. The cyber-physical system is a system that realizes optimal control of the real world by analyzing a huge amount of sensing data obtained from the real world on a computer and feeding back the analysis results. It is expected that such cyber-physical systems will create new values and solutions.

Based on these considerations, an all photonics network (APN) based on photonics technology is being considered as a new architectural network to accommodate traffic that requires large capacity and low latency. An APN is one of transparent networks that transmits arbitrary user signals. APN provides an end-to-end optical path, independent of specific communication protocols and optical modulation schemes.

However, a method for determining the normality (transmission confirmation) of optical signal paths that transparently transmit main signals of various protocols in an APN has not yet been established. Hereinafter, determining the normality of the optical signal path will be referred to as “signal path normality determination”. For example, when a communication error occurs, in order to identify the location where the error has occurred, the optical signal transmission path is divided, and signal path normality determination (normality monitoring) is performed for each divided section. In the signal path normality determination for each section, the transmission of the optical signal is confirmed from one side of the target section of the signal path normality determination to the other side. Here, the transmission confirmation is performed by optical-electrical conversion (hereinafter referred to as “OE conversion”) of at least a part of the optical signal at the end point of the target section for signal path normality determination by terminating the optical signal, or by using a nonlinear optical effect or the like related to the optical signal. Here, the use of nonlinear optical effects or the like refers to using changes in the gain in gain media and light absorption media, and changes in the current and voltage applied to those media, and changes in intensity of pump light input or gain clamp light to those media after passing through the media, and changes in light such as idler light generated by nonlinear optical effects. In signal path normality determination, a loopback method is mainly used in which a response is returned from the other side of the target section in response to a request from one side of the target section. In optical signal loopback, optical-electrical-optical conversion (hereinafter referred to as “OEO conversion”) is required at an optical signal returning point at which a request optical signal is sent at one end point of the target section for optical signal path normality determination or ahead thereof, and the OE conversion that receives the response returns a response to the request at the other end point or ahead thereof.

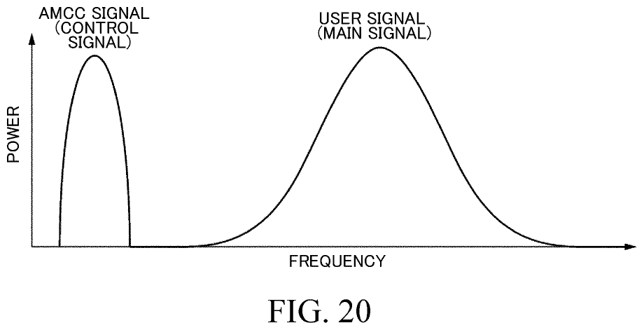

FIG. 20 is a diagram showing an example of the frequency of a control signal and the frequency of a main signal (user signal). In FIG. 20, the control signal is an auxiliary management and control channel (AMCC) signal. In APN, an intra-station photonic gateway (hereinafter referred to as “Ph-GW”) transmits an AMCC signal for which the frequency is superimposed on a main signal to a user device and another device constituting a network such as a Ph-GW. A user device or another device constituting a network such as Ph-GW may transmit an AMCC signal for which the frequency is superimposed on a main signal to another user device or a device constituting a network such as Ph-GW. The AMCC signal may be received by a user device or a device constituting a network such as Ph-GW.

Incidentally, generally, an optical transmitter (for example, user device) and an optical receiver (for example, Ph-GW) are connected via one or more repeaters. A repeater is a relay device that can switch an output destination according to the wavelength of an optical signal, and is, for example, a wavelength selective switch (WSS). It is known that when an optical signal passes through a repeater, it is affected by loss, bandwidth narrowing, or the like (for example, see NPL 1).

### CITATION LIST

### Non Patent Literature

[NPL 1] Yohei Sakamaki, Takeshi Kawai, and Mitsuru Fukutoku, “Optical switch technology to realize more flexible optical nodes,” NTT Technology Journal, November 2013.

### SUMMARY OF INVENTION

### Technical Problem

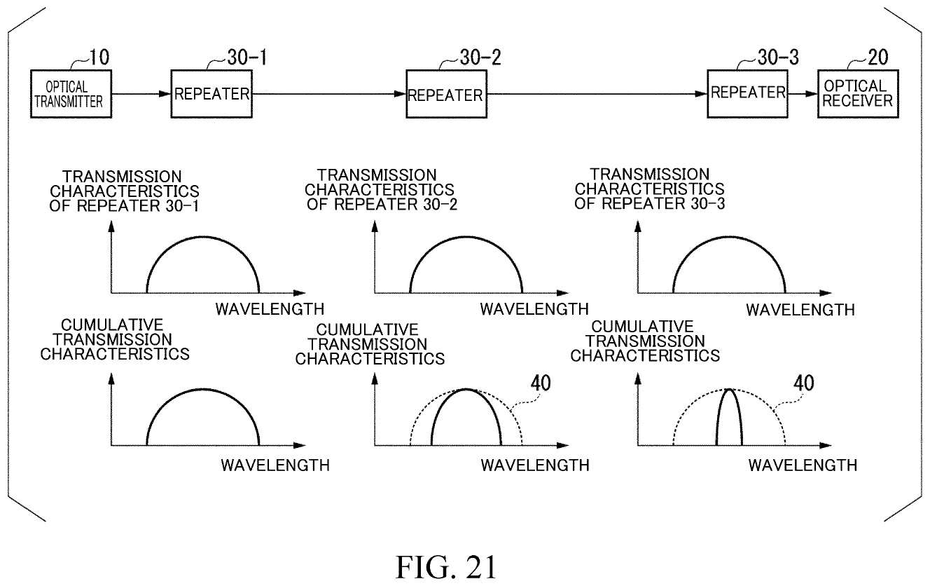

FIG. 21 is a diagram for explaining the influence that an optical signal receives when passing through a plurality of repeaters. FIG. 21 shows an example in which three repeaters 30-1 to 30-3 are provided between an optical transmitter 10 and an optical receiver 20. The middle part of FIG. 21 shows the transmission characteristics of wavelength division multiplexing (WDM) filters included in the repeaters 30-1 to 30-3. For example, the middle part of FIG. 21 shows, from left to right, the transmission characteristics of the WDM filter provided in the repeater 30-1, the transmission characteristics of the WDM filter provided in the repeater 30-2, and the transmission characteristics of the WDM filter provided in the repeater 30-3.

The lower part of FIG. 21 shows the cumulative transmission characteristics. Note that, in the lower part of FIG. 21, dotted lines 40 indicate individual transmission characteristics. As shown in FIG. 21, it can be seen that the transmission characteristics become narrower each time the optical signal passes through a repeater. When such narrowing occurs, transmission characteristics deteriorate. Therefore, it is important to understand the transmission characteristics, which are characteristics related to a transmission path.

Conventionally, as a method for monitoring characteristics related to a transmission path, a transmitting side is equipped with a broadband light source or a wavelength-tunable light source, and a receiving side is equipped with an optical spectrum analyzer to specify the wavelength that passes. However, since optical spectrum analyzers are expensive measuring instruments, there is a problem that it is not easy to specify transmission characteristics, which are characteristics related to a transmission path between an optical transmitter and an optical receiver with a cheaper configuration. Note that such a problem is not limited to optical transmitters and optical receivers in APN, but is common to all optical communication systems that transmit and receive optical signals.

In view of the above-mentioned circumstances, an object of the present invention is to provide a communication system, a first optical communication system, and a transmission path characteristics specifying method with which it is possible to easily specify transmission characteristics, which are characteristics related to a transmission path between an optical transmitter and an optical receiver with a cheaper configuration.

### Solution to Problem

One aspect of a present invention provides a communication system including: one or more first optical communication devices; a second optical communication device that communicates with the one or more first optical communication devices; and a transmission path that connects the one or more first optical communication devices and the second optical communication device, wherein the one or more first optical communication devices include: a transmitting unit that transmits an optical signal having a wavelength within a wavelength range for confirmation transmission characteristics in the optical transmission path to the second optical communication device via the optical transmission path, the communication system including: a specifying unit that specifies the transmission characteristics in the optical transmission path based on an optical signal having a wavelength within the wavelength range transmitted from the one or more first optical communication devices.

One aspect of a present invention provides a first optical communication device in a communication system including: the first optical communication device; a second optical communication device that communicates with the first optical communication device; and a transmission path that connects the first optical communication device and the second optical communication device, the first optical communication device including: a transmitting unit that transmits a wavelength-swept optical signal to the second optical communication device via the optical transmission path; and a specifying unit that receives either a reception result of the wavelength-swept optical signal or an optical signal returned from the second optical communication device and specifies transmission characteristics in the optical transmission path.

One aspect of a present invention provides a transmission path characteristics specifying method executed by a communication system including: one or more first optical communication devices; a second optical communication device that communicates with the one or more first optical communication devices; and a transmission path that connects the one or more first optical communication devices and the second optical communication device, the method including: allowing the one or more first optical communication devices to transmit an optical signal having a wavelength within a wavelength range for confirmation transmission characteristics in the optical transmission path to the second optical communication device via the optical transmission path; and allowing a specifying unit to specify the transmission characteristics in the optical transmission path based on an optical signal having a wavelength within the wavelength range transmitted from the one or more first optical communication devices.

### Advantageous Effects of Invention

According to the present invention, it is possible to easily specify transmission characteristics, which are characteristics related to a transmission path between an optical transmitter and an optical receiver with a cheaper configuration.

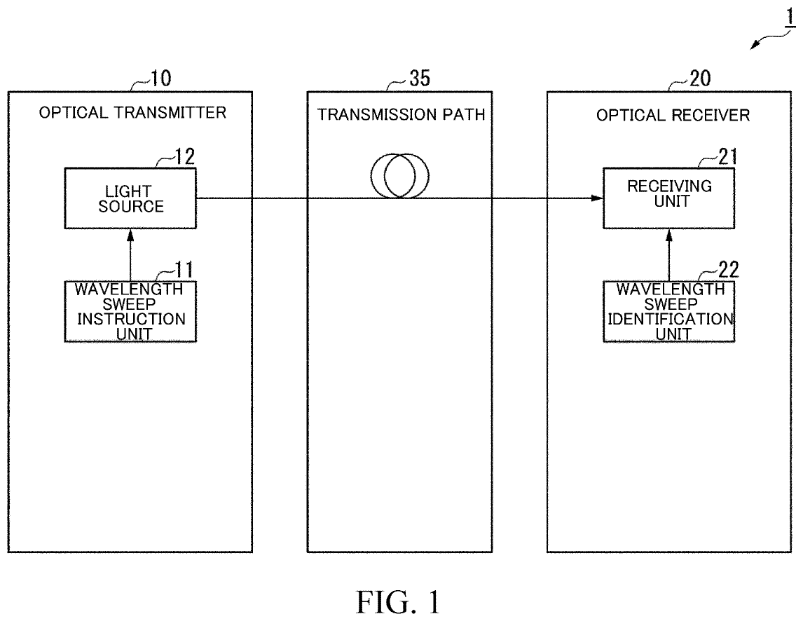

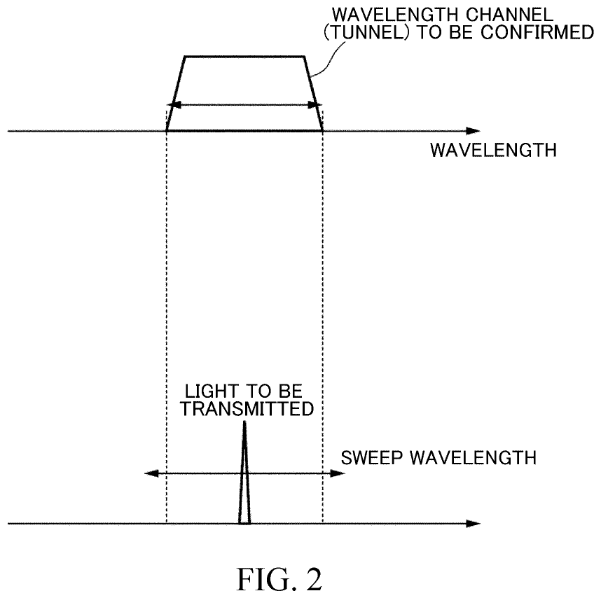

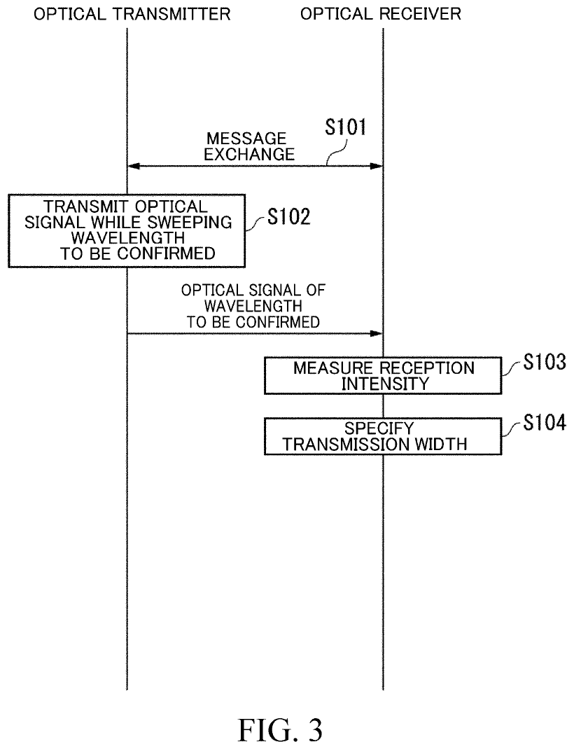

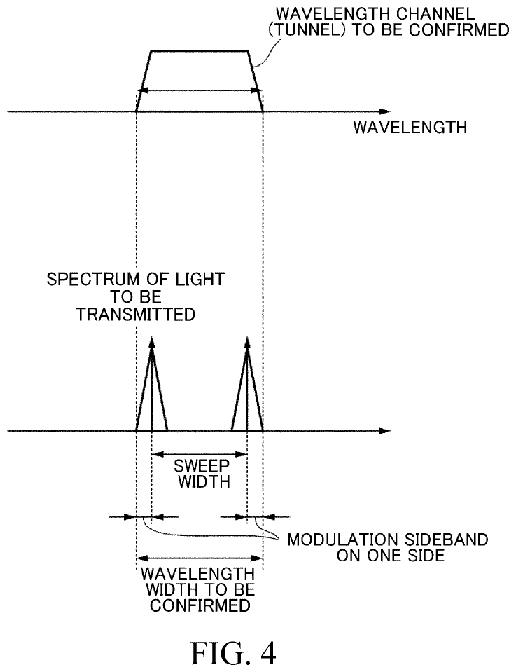

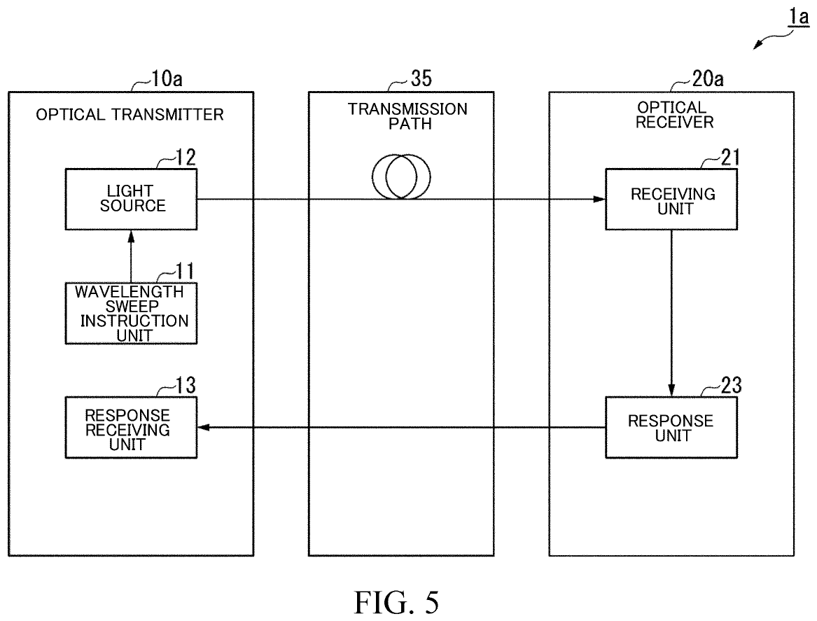

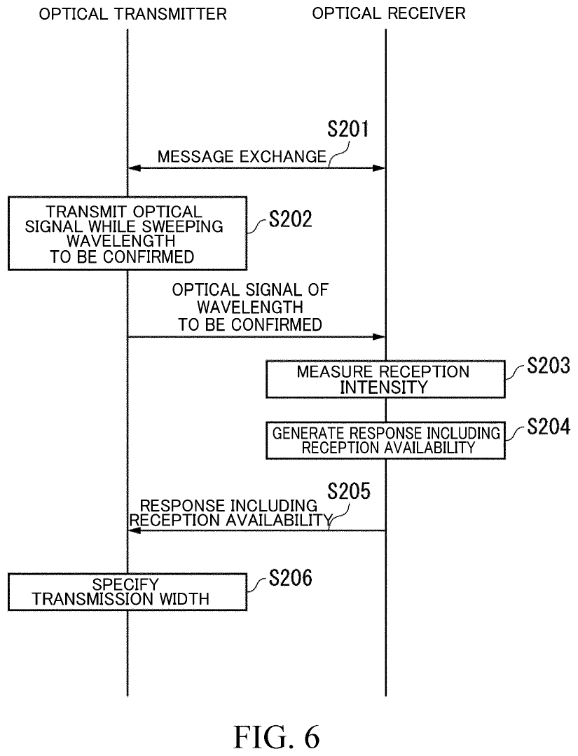

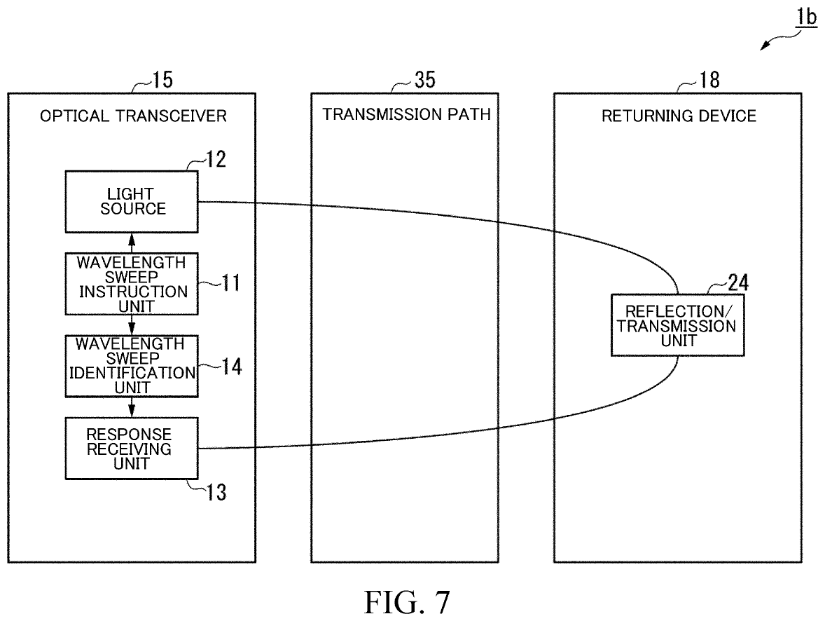

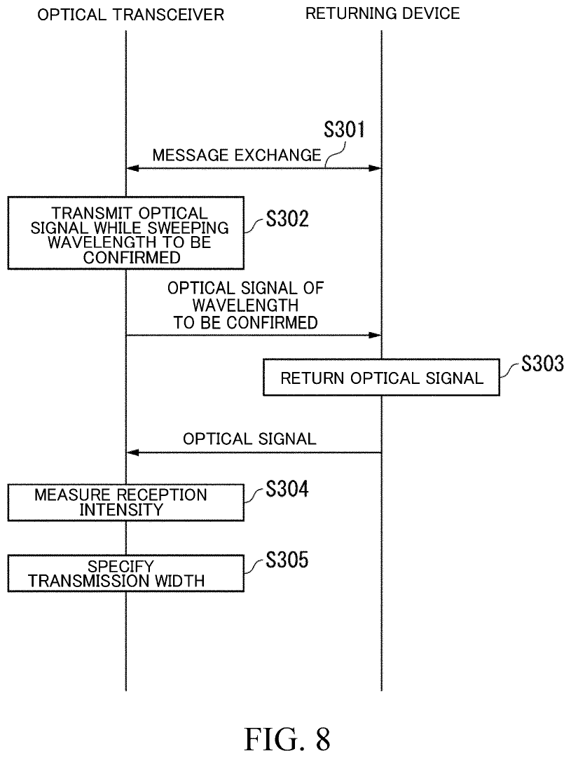

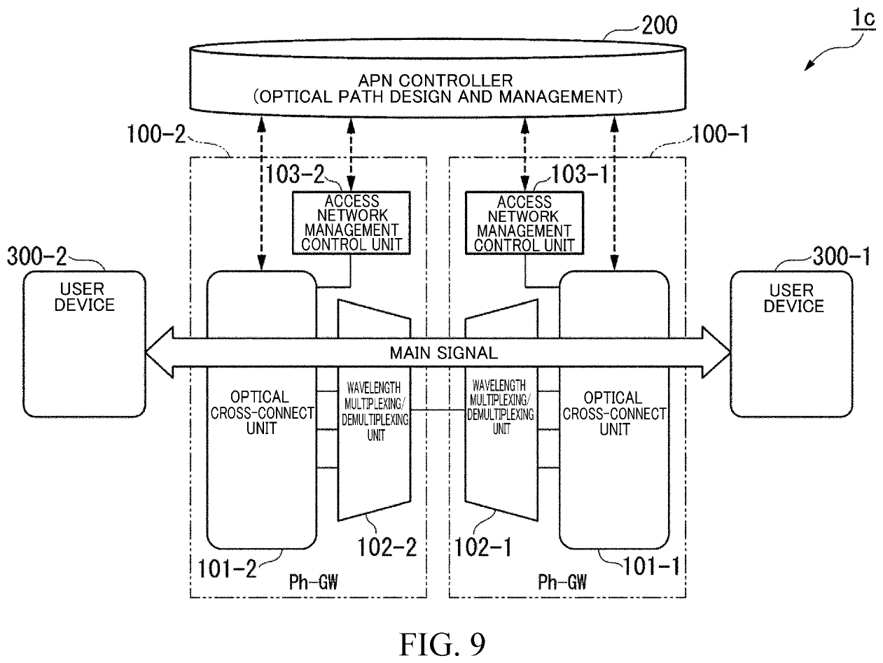

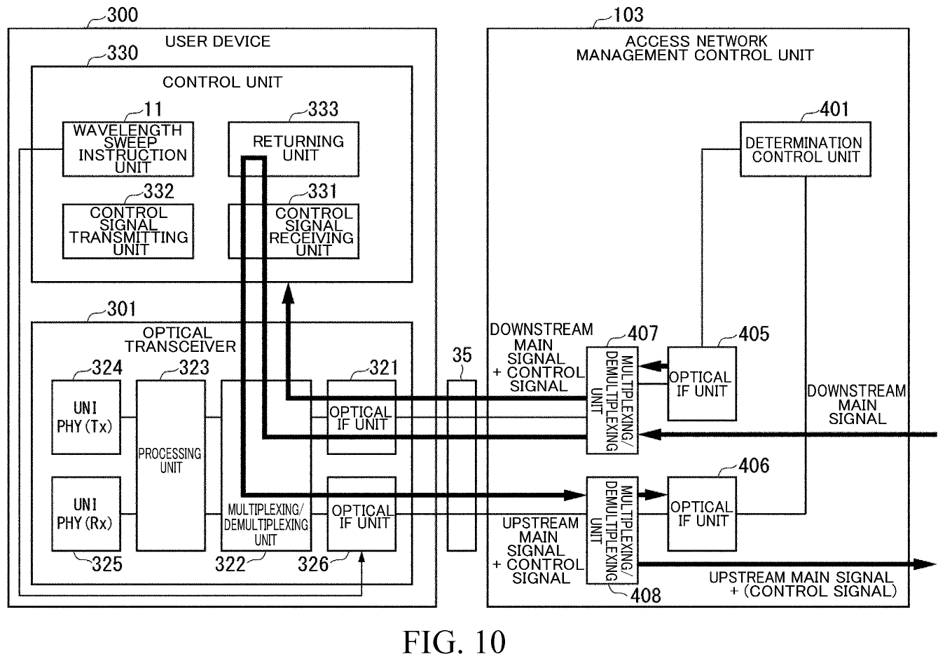

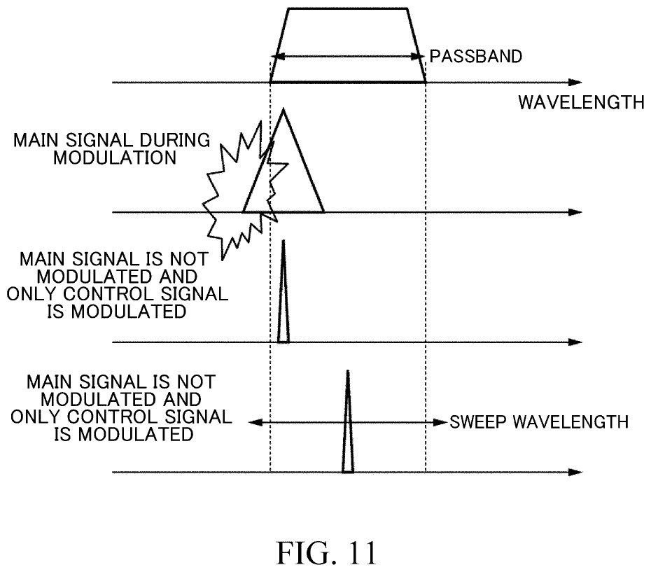

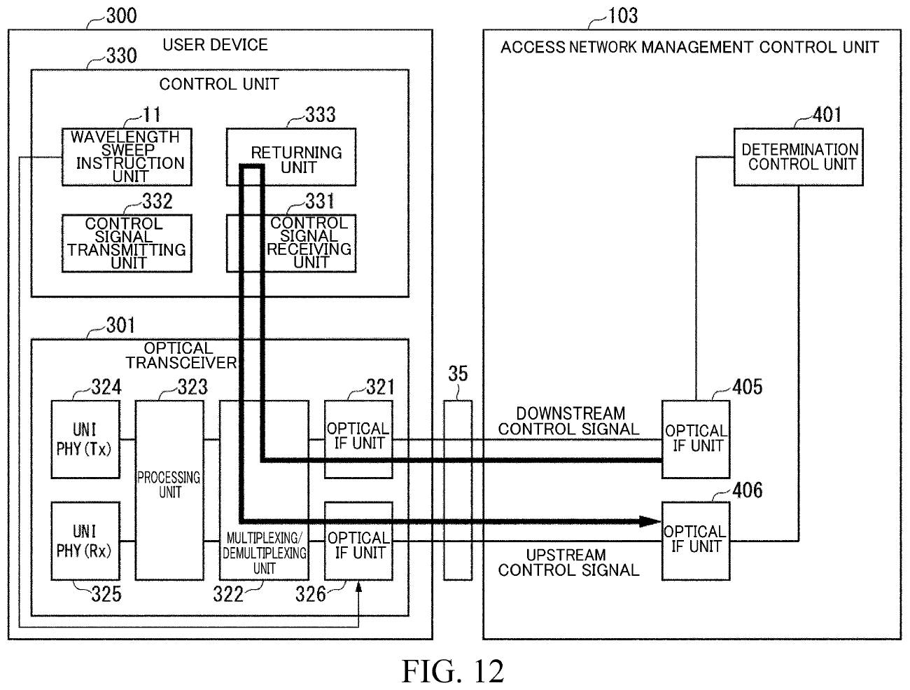

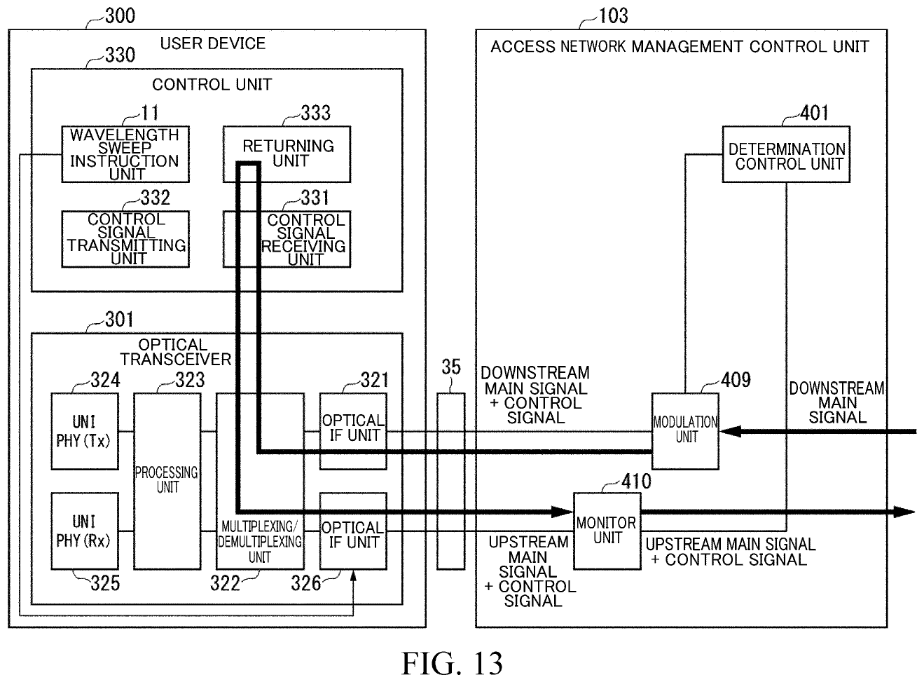

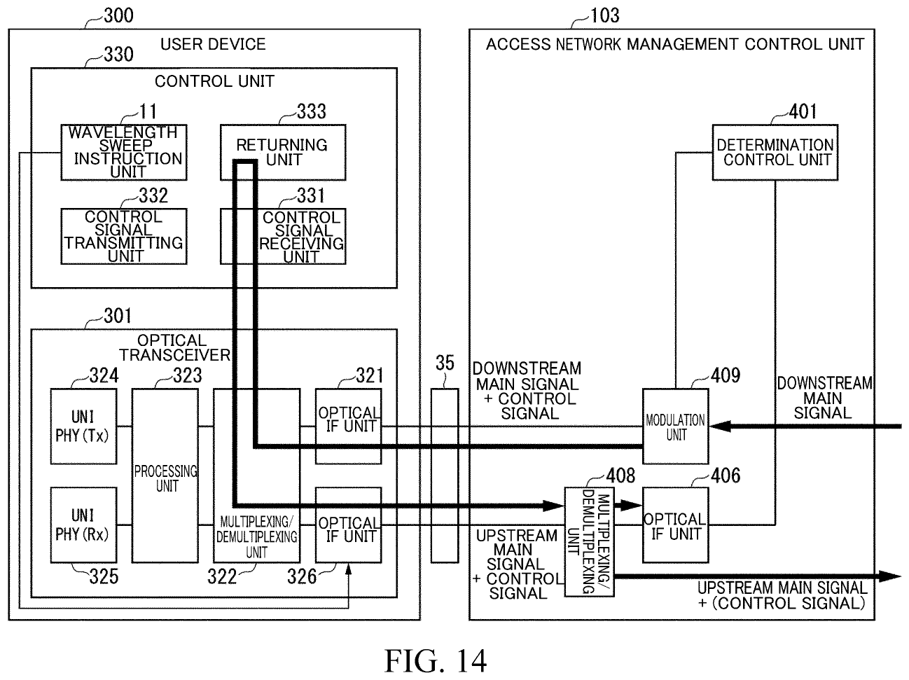

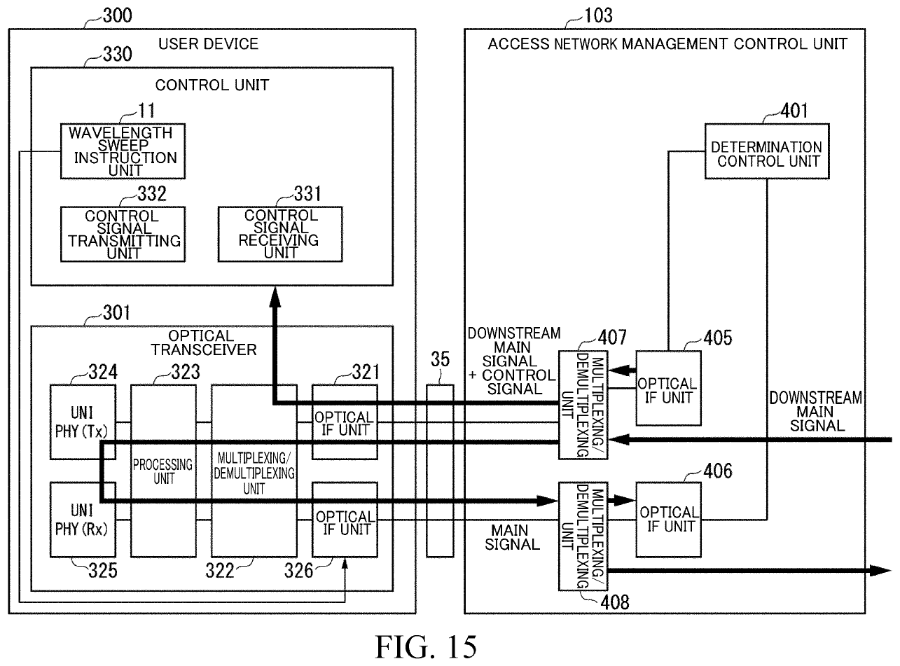

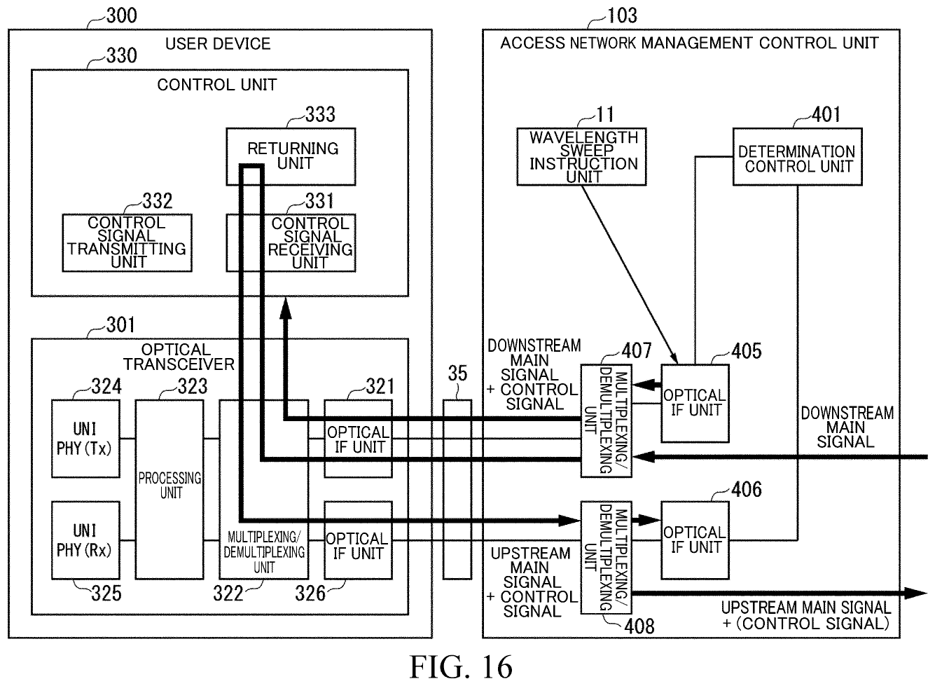

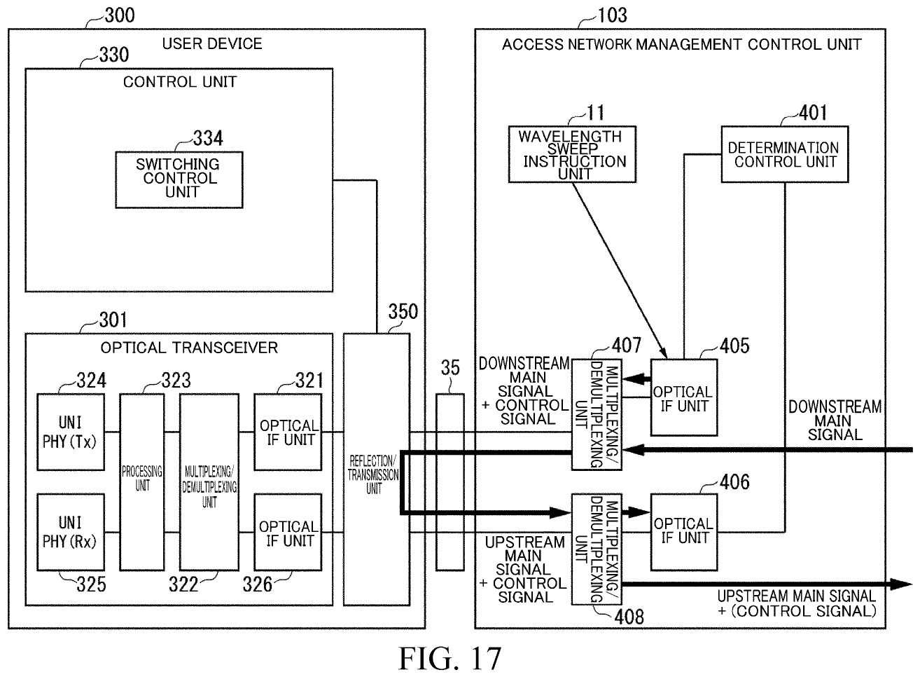

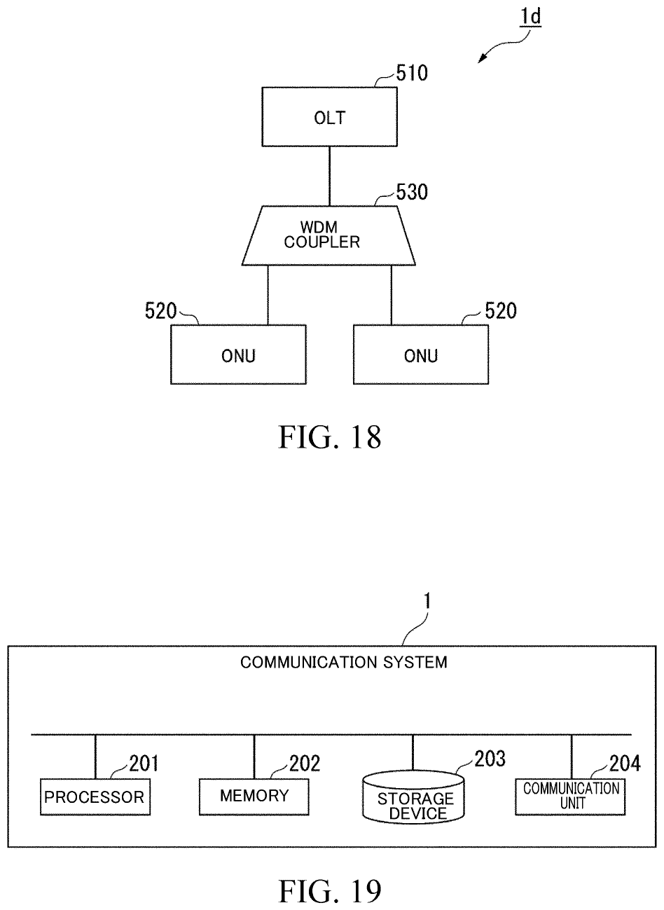

### BRIEF DESCRIPTION OF DRAWINGS

[FIG. 1] A diagram showing a configuration example of a communication system in a first embodiment.

[FIG. 2] A diagram showing an example of an optical signal transmitted by an optical transmitter in the first embodiment.

[FIG. 3] A diagram showing the flow of a wavelength channel width transmission confirmation process performed by the communication system in the first embodiment.

[FIG. 4] A diagram illustrating an example of an optical signal transmitted by an optical transmitter when the optical signal transmitted by the optical transmitter is a modulated optical signal.

[FIG. 5] A diagram illustrating a configuration example of a communication system in a second embodiment.

[FIG. 6] A diagram showing the flow of a wavelength channel width transmission confirmation process performed by the communication system in the second embodiment.

[FIG. 7] A diagram illustrating a configuration example of a communication system in a third embodiment.

[FIG. 8] A diagram showing the flow of a wavelength channel width transmission confirmation process performed by the communication system in the third embodiment.

[FIG. 9] A diagram showing a configuration example of a communication system that communicates using a communication network such as an all photonics network (APN).

[FIG. 10] A diagram showing a configuration example (part 1) of a communication system in a fourth embodiment.

[FIG. 11] A diagram illustrating a supplementary explanation of the configuration when AMCC is used as in the communication system in the fourth embodiment.

[FIG. 12] A diagram showing a configuration example (part 2) of the communication system in the fourth embodiment.

[FIG. 13] A diagram showing a configuration example (part 3) of the communication system in the fourth embodiment.

[FIG. 14] A diagram showing a configuration example (part 4) of the communication system in the fourth embodiment.

[FIG. 15] A diagram showing a configuration example of a communication system in Modified Example 7 of the fourth embodiment.

[FIG. 16] A diagram showing a configuration example of a communication system in a fifth embodiment.

[FIG. 17] A diagram showing a configuration example of a communication system in Modified Example 6 of the fifth embodiment.

[FIG. 18] A diagram showing an example of the configuration of a communication system in a sixth embodiment.

[FIG. 19] A diagram illustrating a hardware configuration example of a communication system in an embodiment.

[FIG. 20] A diagram showing an example of the frequency of a control signal and the frequency of a main signal (user signal).

[FIG. 21] A diagram for explaining the influence that an optical signal receives when passing through a plurality of repeaters.

### DESCRIPTION OF EMBODIMENTS

Hereinafter, an embodiment of the present invention will be described with reference to the drawings.

### Outline

The communication system according to the present invention is a system that specifies transmission characteristics, which are characteristics related to a transmission path between an optical transmitter and an optical receiver. Here, specifying the transmission characteristics means confirmation the width of a wavelength channel (wavelength tunnel) that can be transmitted on a transmission path. An optical transmitter and an optical receiver in a communication system share information indicating a wavelength (hereinafter referred to as “swept wavelength information”) by, for example, time synchronization or message exchange.

The optical receiver notifies the optical transmitter whether the optical signal can be received at respective wavelengths. In this way, the transmission characteristics can be specified. For example, the wavelength of one light source provided in a first optical communication device (corresponding to an optical transmitter or optical transceiver) is swept according to the width of a wavelength channel to be confirmed for transmission, and the transmission of optical signals of respective wavelengths is confirmed. Alternatively, the transmission of each optical signal of a plurality of first optical communication devices (corresponding to optical transmitters and optical transceivers) corresponding to the wavelength obtained by dividing the wavelength channel width to be subject to wavelength sweeping by a plurality of light sources is confirmed. In this way, the bandwidth of the wavelength channel width (wavelength tunnel) that can be received by the optical receiver is confirmed. Note that the sweep width may be the width obtained by subtracting the modulation sideband on one side of a modulation from the width of the wavelength channel to be confirmed for transmission.

Furthermore, as for the timing for specifying the transmission characteristics, it may be executed at the time of initial setting when the main signal is not transmitted, or may be executed at the time of loopback. Here, loopback is a method used for signal path normality determination as described above.

The sweep status may be confirmed after identifying it using any of (1) to (4) below.
(1) An optical transmitter notifies an optical receiver of the sweep status, and the transmission width is confirmed based on the transmission intensity corresponding to the notification.
(2) Time synchronization with the optical receiver is achieved, the sweep speed, sweep start wavelength, and sweep start time are shared, and the transmission width is confirmed based on the transmission intensity at the time after the propagation delay from the start time.
(3) The optical receiver notifies acknowledgment corresponding to the transmission intensity, and the optical transmitter confirms the transmission width based on the acknowledgment.

The reception notification may be a notification including intensity information, or may be returned at the intensity corresponding to the signal intensity received by the opposing device.

The received light may be returned as it is. However, when the received light is returned as it is, characteristics that are narrowed during the round trip will be observed.
(4) When notification is performed using an optical signal with a wavelength different from the wavelength of the wavelength-swept light, the wavelength can be swept using continuous wave (CW) light. When notification is performed using wavelength-swept light, at least the light carrying the notification is modulated light.

Hereinafter, a specific configuration for realizing the process of specifying the above-mentioned transmission characteristics will be described.

### First Embodiment

In the first embodiment, a configuration will be described in which, in a communication system including an optical transmitter and an optical receiver, the optical receiver specifies the transmission characteristics of a transmission path between the optical transmitter and the optical receiver. More specifically, in the first embodiment, an optical transmitter transmits an optical signal of respective wavelengths while sweeping the wavelength of a light source, and an optical receiver converts the optical signal of respective wavelengths into an electrical signal, measures the reception intensity, specifies which wavelength is being transmitted, and specifies the transmission width.

FIG. 1 is a diagram showing a configuration example of a communication system 1 in the first embodiment. The communication system 1 includes an optical transmitter 10 and an optical receiver 20. The optical transmitter 10 and the optical receiver 20 are connected via a transmission path 35. The transmission path 35 is a path for which the transmission characteristics are to be measured. Note that a plurality of optical transmitters 10 and a plurality of optical receivers 20 may be provided.

When the communication system 1 includes a plurality of optical transmitters 10, each optical transmitter 10 may emit an optical signal with a different fixed wavelength within the wavelength range to be confirmed for transmission, or the sweep width may be determined for each optical transmitter 10. When each optical transmitter 10 emits an optical signal with a different fixed wavelength within the wavelength range to be confirmed for transmission, only a number of optical transmitters 10 that cover the wavelength range to be confirmed for transmission is required.

The optical transmitter 10 includes a wavelength sweep instruction unit 11 and a light source 12. The wavelength sweep instruction unit 11 instructs the light source 12 to sweep the wavelength channel to be confirmed for transmission. The light source 12 is a wavelength-tunable light source for which the wavelength can be changed. The light source 12 transmits an optical signal of respective wavelengths included in the sweep width instructed by the wavelength sweep instruction unit 11 in a predetermined order, for example, in ascending order, descending order, or random order. That is, the light source 12 transmits a wavelength-swept optical signal according to the instructions from the wavelength sweep instruction unit 11. Note that the light source 12 may transmit the optical signal of respective wavelengths without modulating them. The optical transmitter 10 is one aspect of a first optical communication device. The light source 12 is one aspect of a transmitting unit.

The optical receiver 20 includes a receiving unit 21 and a wavelength sweep identification unit 22. The receiving unit 21 receives an optical signal of respective wavelengths transmitted from the optical transmitter 10. The receiving unit 21 includes a receiver that is sufficiently wavelength-independent at the wavelength for which the transmission characteristics are to be measured. A wavelength-independent receiver is, for example, a photodiode equipped with a wavelength filter or the like. For example, in the case of the 1500 nm band, a photodiode made of InGaAs, which is a semiconductor with a bandgap corresponding to the desired wavelength and has a small change depending on the wavelength, is a candidate. Note that the wavelength dependence may be compensated by multiplying by a multiplier corresponding to the designated wavelength or by changing the bias so as not to be effectively dependent. The receiving unit 21 converts the received optical signal into an electrical signal and then measures the reception intensity. The receiving unit 21 specifies the transmission width based on the measurement result and the information held by the wavelength sweep identification unit 22. The optical receiver 20 is one aspect of a second optical communication device. The receiving unit 21 is one aspect of a specifying unit.

The wavelength sweep identification unit 22 holds swept wavelength information obtained in advance through message exchange between the optical transmitter 10 and the optical receiver 20. The swept wavelength information includes at least information specifying the wavelength to be swept.

FIG. 2 is a diagram showing an example of an optical signal transmitted by the optical transmitter 10 in the first embodiment. As shown in FIG. 2, the optical transmitter 10 sweeps the wavelength and transmits an optical signal corresponding to the swept wavelength to the optical receiver 20. For example, as shown in FIG. 2, when the wavelength channel to be confirmed is specified by the wavelength sweep identification unit 22, the optical transmitter 10 may transmit the optical signal while sweeping the wavelength with the width of the wavelength channel to be confirmed, or a width slightly broader than the width of the wavelength channel to be confirmed. In this way, it is possible to confirm transmission of at least the width of the wavelength channel to be confirmed. Note that the transmission confirmation may include confirmation the wavelength dependence of the loss of the transmission path (which may include a relay device) between the optical transmitter 10 and the optical receiver 20.

FIG. 3 is a diagram showing the flow of a wavelength channel width transmission confirmation process performed by the communication system 1 in the first embodiment. Note that, in the process of FIG. 3, a case will be described in which swept wavelength information is shared between the optical transmitter 10 and the optical receiver 20 by exchanging messages. The process in FIG. 3 is executed, for example, at the time of initial setting when the main signal is not transmitted, or when transmission confirmation.

The optical transmitter 10 and the optical receiver 20 share swept wavelength information by exchanging messages (step S101). Specifically, the optical transmitter 10 shares the swept wavelength information by transmitting a message including the swept wavelength information to the optical receiver 20. Here, the swept wavelength information includes information indicating which wavelength of the optical signal is transmitted by the optical transmitter 10. The wavelength sweep instruction unit 11 instructs the light source 12 to sweep the wavelength channel to be confirmed. For example, the wavelength sweep instruction unit 11 instructs the light source 12 to sweep the wavelength channel along with information on the sweep width of the wavelength channel to be confirmed.

The swept wavelength information may be a combination of transmission start time, transmission start wavelength, amount of wavelength change per time, and transmission end wavelength, a combination of transmission start time, transmission start wavelength, amount of wavelength change per time, and sweep end time, or a combination of transmission start time, transmission start wavelength, amount of wavelength change per time, and sweep width. Alternatively, the time from the instruction to the start of transmission, the amount of wavelength change per time, and the sweep end time or sweep width may be determined in advance between the optical transmitter 10 and the optical receiver 20, and the sweep wavelength information may be a combination of the transmission start wavelength, the center wavelength of the sweep, and the wavelength channel to be confirmed (corresponding to (2) of the sweep status). In addition, although this is outside the flow of FIG. 3, the transmission wavelength may be instructed, the transmission wavelength corresponding to the instruction may be transmitted, the reception intensity may be measured, then the transmission wavelength may be changed and instructed, and the reception intensity may be measured.

This process may be repeated until the entire wavelength width to be confirmed is measured (corresponding to (1) in the sweep status). In addition, in FIG. 3, the transmission width is specified by the optical receiver 20, but the reception result may be transmitted to the optical transmitter 10 side by message exchange from the receiving side (for example, the optical receiver 20), and the transmission width may be specified on the optical transmitter 10 side (corresponding to (3) in the sweep status). The sweep status may be confirmed after identifying it using any of (1) to (4) above.

The light source 12 transmits an optical signal of respective wavelengths to the optical receiver 20 via the transmission path 35 while sweeping the wavelength to be confirmed based on the information on the sweep width according to the instruction from the wavelength sweep instruction unit 11 (step S102). For example, the light source 12 repeatedly emits laser light within a wavelength range determined by the sweep width while continuously changing the wavelength of the laser at a predetermined sweep speed. Note that the light source 12 may transmit an optical signal only once for respective wavelengths, without repeatedly emitting light in the wavelength range determined by the sweep width, unless there is a reason such as reducing errors.

The receiving unit 21 of the optical receiver 20 receives the optical signal of respective wavelengths transmitted from the optical transmitter 10. Every time the receiving unit 21 receives an optical signal, the receiving unit 21 converts the received optical signal into an electrical signal and measures the reception intensity (step S103). For example, when the optical transmitter 10 repeatedly transmits an optical signal in the wavelength range from wavelength λ₁ to wavelength λ₁₀, the receiving unit 21 converts an optical signal of respective wavelengths from λ₁ to wavelength λ₁₀ into electrical signals and measures the reception intensity.

The receiving unit 21 specifies the transmission width based on the swept wavelength information held by the wavelength sweep identification unit 22 and the measured reception intensity (step S104). Specifically, when a reception intensity equal to or greater than a predetermined threshold value is obtained, the receiving unit 21 determines that the optical signal of the wavelength for which the reception intensity is equal to or greater than the threshold value is receivable. Note that the receiving unit 21 may measure the wavelength-dependent loss for each received optical signal and specify the transmission width based on the reception intensity and the wavelength-dependent loss. For example, the receiving unit 21 determines that an optical signal of a wavelength for which the wavelength-dependent loss is less than a threshold value and for which the reception intensity is equal to or greater than the threshold value can be received. On the other hand, the receiving unit 21 determines that an optical signal of a wavelength for which the wavelength-dependent loss is equal to or greater than the threshold value or for which the reception intensity is less than the threshold value cannot be received.

On the other hand, when the reception intensity is less than the predetermined threshold, the receiving unit 21 determines that the optical signal of the wavelength for which the reception intensity is less than the threshold cannot be received. The threshold value is determined for respective wavelengths. The receiving unit 21 performs this process on all an optical signal of respective wavelengths transmitted from the optical transmitter 10. Then, the receiving unit 21 specifies the range of wavelengths determined to be receivable as the transmission width.

According to the communication system 1 configured as described above, it becomes possible to easily specify the transmission characteristics, which are characteristics related to the transmission path between the optical transmitter and the optical receiver with a cheaper configuration. Specifically, in the communication system 1, the optical receiver 20 converts the received optical signal into an electrical signal and specifies the transmission width based on the reception intensity of the electrical signal and the swept wavelength information. In this way, even if the optical receiver 20 is not equipped with an optical spectrum analyzer, the transmission characteristics which are characteristics related to the transmission path can be specified. Therefore, it becomes possible to easily specify the transmission characteristics which are the characteristics related to the transmission path between the optical transmitter and the optical receiver with a cheaper configuration.

### Modified Example 1 of First Embodiment

The optical transmitter 10 may modulate and transmit an optical signal of respective wavelengths. When configured in this way, the optical transmitter 10 includes a modulation unit that modulates an optical signal. When the optical signal transmitted by the optical transmitter 10 is a modulated optical signal, as shown in FIG. 4, the optical transmitter 10 may transmit the optical signal by sweeping the wavelength in a wavelength range with a width obtained by subtracting the modulation sideband on one side of a modulation from the width of the wavelength channel to be confirmed for transmission. FIG. 4 is a diagram showing an example of an optical signal transmitted by the optical transmitter 10 when the optical signal transmitted by the optical transmitter 10 is a modulated optical signal. With this configuration, the sweep width can be reduced. Furthermore, when an optical signal of respective wavelengths is modulated and transmitted, messages can be exchanged. However, when exchanging messages, the width and depth of the modulation sideband change depending on the content of the message. Therefore, it is desirable to continue measurement at respective wavelengths for a time period that includes a message that can be considered random on a time average, or to transmit random data that can be considered random in addition to the message.

From the viewpoint of reducing the sweep width as described above, when the optical transmitter 10 modulates the optical signal of respective wavelengths, it is desirable to perform steep modulation or random modulation so as to have a broad frequency component. For example, this is because, when modulating with a single sine wave, the main sideband has only one ±1st-order modulation sideband on both sides of the carrier wave, which has only the width of the frequency fluctuation of the sine wave, so gaps are leaved. From the viewpoint of increasing the sensitivity of transmission in the modulation component, it is desirable that the intensity of the modulation sideband be modulated deeply. Note that it may be deep enough to eliminate non-modulated components.

### Modified Example 2 of First Embodiment

When time synchronization is performed between the optical transmitter 10 and the optical receiver 20, the swept wavelength information may include information on the sweep speed, sweep start wavelength, and sweep start time. When configured in this way, the receiving unit 21 of the optical receiver 20 compares the sweep start time included in the swept wavelength information with the reception time of the optical signal to specify the wavelength of the received optical signal (corresponding to sweep status (2)).

### Second Embodiment

In the second embodiment, a configuration will be described in which, in a communication system including an optical transmitter and an optical receiver, the optical transmitter specifies the transmission characteristics of the transmission path between the optical transmitter and the optical receiver. More specifically, in the second embodiment, an optical transmitter transmits an optical signal of respective wavelengths while sweeping the wavelength of a light source, and an optical receiver specifies the transmission width by transmitting information on success or failure in reception of the optical signal to the optical transmitter as a response.

FIG. 5 is a diagram showing a configuration example of a communication system la in the second embodiment. The communication system la includes an optical transmitter 10a and an optical receiver 20a. The optical transmitter 10a and the optical receiver 20a are connected via a transmission path 35. Note that a plurality of optical transmitters 10a and optical receivers 20a may be provided.

When the communication system la includes a plurality of optical transmitters 10a, each optical transmitter 10a may emit an optical signal with a different fixed wavelength within the wavelength range to be confirmed for transmission, or the sweep width may be determined for each optical transmitter 10a. When each optical transmitter 10a emits an optical signal with a different fixed wavelength within the wavelength range to be confirmed for transmission, only a number of optical transmitters 10a that cover the wavelength range to be confirmed for transmission is required.

The optical transmitter 10a includes a wavelength sweep instruction unit 11, a light source 12, and a response receiving unit 13. The optical transmitter 10a differs in configuration from the optical transmitter 10 in that it additionally includes the response receiving unit 13. The other configuration of the optical transmitter 10a is the same as that of the optical transmitter 10.

The response receiving unit 13 receives the optical signal transmitted from the optical receiver 20a. The optical signal transmitted from the optical receiver 20a includes information on success or failure in reception of the optical signal of respective wavelengths swept by the light source 12. In the optical transmitter 10a, the transmission width can be specified based on the information on the wavelength of the optical signal successfully received by the optical receiver 20a. The response receiving unit 13 is one aspect of a specifying unit.

The optical receiver 20a includes a receiving unit 21 and a response unit 23. The optical receiver 20a differs in configuration from the optical receiver 20 in that it does not include the wavelength sweep identification unit 22 but includes the response unit 23. The other configuration of the optical receiver 20a is the same as that of the optical receiver 20. Note that the optical receiver 20a may include the wavelength sweep identification unit 22 when deciding by compensating for wavelength dependence.

Based on the optical signal received by the receiving unit 21, the response unit 23 transmits a response including information of either success or failure in reception of the optical signal of respective wavelengths to the optical transmitter 10a. Success or failure in reception can be determined based on the reception intensity as in the first embodiment.

FIG. 6 is a diagram showing the flow of a wavelength channel width transmission confirmation process performed by the communication system la in the second embodiment. Note that, in the process of FIG. 6, a case will be described in which swept wavelength information is shared between the optical transmitter 10a and the optical receiver 20a through message exchange. The process in FIG. 6 is executed, for example, at the time of initial setting when the main signal is not transmitted, or when transmission confirmation.

The optical transmitter 10a and the optical receiver 20a share swept wavelength information by exchanging messages (step S201). Specifically, the optical transmitter 10a shares the swept wavelength information by transmitting a message including the swept wavelength information to the optical receiver 20a. Note that when the optical receiver 20a is the main entity that confirms the transmission width, the optical receiver 20a shares the swept wavelength information by transmitting the swept wavelength information to the optical transmitter 10a. However, when specifying the transmission width in the optical transmitter 10a, message exchange for sharing swept wavelength information may be performed.

The wavelength sweep instruction unit 11 of the optical transmitter 10a instructs the light source 12 to sweep the wavelength channel to be confirmed. For example, the wavelength sweep instruction unit 11 instructs the light source 12 to sweep the wavelength channel along with information on the sweep width of the wavelength channel to be confirmed. The light source 12 transmits an optical signal of respective wavelengths to the optical receiver 20a via the transmission path 35 while sweeping the wavelength to be confirmed based on the information on the sweep width according to the instruction from the wavelength sweep instruction unit 11 (step S202).

The receiving unit 21 of the optical receiver 20a receives an optical signal of respective wavelengths transmitted from the optical transmitter 10a. Every time the receiving unit 21 receives an optical signal, the receiving unit 21 converts the received optical signal into an electrical signal and measures the reception intensity (step S203). The receiving unit 21 determines whether reception of the optical signal of respective wavelengths is successful or unsuccessful based on the measured reception intensity. Specifically, when a reception intensity equal to or greater than a predetermined threshold value is obtained, the receiving unit 21 determines that the optical signal of the wavelength for which the reception intensity is equal to or greater than the threshold value is receivable. Note that the receiving unit 21 may measure the wavelength-dependent loss for each received optical signal and specify the transmission width based on the reception intensity and the wavelength-dependent loss. For example, the receiving unit 21 determines that an optical signal of a wavelength for which the wavelength-dependent loss is less than a threshold value and for which the reception intensity is equal to or greater than the threshold value can be received. On the other hand, the receiving unit 21 determines that an optical signal of a wavelength for which the wavelength-dependent loss is equal to or greater than the threshold value or for which the reception intensity is less than the threshold value cannot be received.

The receiving unit 21 outputs the determination result to the response unit 23. The response unit 23 generates a response including information on whether reception availability for the optical signal of respective wavelengths according to the determination result output from the receiving unit 21 (step S204). The response unit 23 transmits the generated response to the optical transmitter 10a via the transmission path 35 (step S205).

The response receiving unit 13 of the optical transmitter 10a receives the response transmitted from the optical receiver 20a. The response receiving unit 13 specifies the transmission width based on the information on reception availability included in the received response (step S206). Specifically, the response receiving unit 13 specifies the range of wavelengths that are shown to be receivable as the transmission width.

According to the communication system la configured as described above, the optical receiver 20a notifies the optical transmitter 10a of a response indicating whether the optical signal of respective wavelengths transmitted by the optical transmitter 10a can be received, and the optical transmitter 10a specifies the transmission width. In this way, even if the optical receiver 20a is not equipped with an optical spectrum analyzer, the transmission characteristics which are characteristics related to the transmission path can be specified. Therefore, it becomes possible to easily specify the transmission characteristics which are the characteristics related to the transmission path between the optical transmitter and the optical receiver with a cheaper configuration.

### Modified Example 1 of Second Embodiment

The optical transmitter 10a may modulate and transmit an optical signal of respective wavelengths. When configured in this way, the optical transmitter 10a includes a modulation unit that modulates the optical signal. When the optical signal transmitted by the optical transmitter 10a is a modulated optical signal, the optical transmitter 10a may transmit the optical signal by sweeping the wavelength in a wavelength range with a width obtained by subtracting the modulation sideband on one side from the width of the wavelength channel to be confirmed for transmission, as in the first embodiment. With this configuration, the sweep width can be reduced. Furthermore, when an optical signal of respective wavelengths is modulated and transmitted, messages can be exchanged. However, when exchanging messages, the width and depth of the modulation sideband change depending on the content of the message. Therefore, it is desirable to continue measurement at respective wavelengths for a time period that includes a message that can be considered random on a time average, or to transmit random data that can be considered random in addition to the message.

From the viewpoint of reducing the sweep width as described above, when the optical transmitter 10a modulates the optical signal of respective wavelengths, it is desirable to perform steep modulation or random modulation so as to have a broad frequency component. For example, this is because, when modulating with a single sine wave, there is only one modulation sideband on each side, which has only the width of the frequency fluctuation of the sine wave, so gaps are leaved. From the viewpoint of increasing the sensitivity of transmission in the modulation component, it is desirable that the intensity of the modulation sideband be modulated deeply. Note that it may be deep enough to eliminate non-modulated components.

### Modified Example 2 of Second Embodiment

When time synchronization is performed between the optical transmitter 10a and the optical receiver 20a, the swept wavelength information may include information on the sweep speed, sweep start wavelength, and sweep start time. When configured in this way, the receiving unit 21 of the optical receiver 20a compares the sweep start time included in the swept wavelength information with the reception time of the optical signal to specify the wavelength of the received optical signal (corresponding to sweep status (2)).

### Modified Example 3 of Second Embodiment

In the above-described example, the optical receiver 20a transmits information on success or failure in reception of an optical signal to the optical transmitter 10a as a response. The optical receiver 20a may not only transmit information on success or failure in reception of the optical signal as a response, but also transmit information on the reception intensity as a response to the optical transmitter 10a. When configured in this way, the response receiving unit 13 of the optical transmitter 10a performs the same determination as the optical receiver 20a. For example, the response receiving unit 13 determines whether an optical signal of respective wavelengths can be received based on information on reception intensity. Then, the response receiving unit 13 specifies the range of wavelengths determined to be receivable as the transmission width. In this way, if the optical receiver 20a or the optical transmitter 10a has wavelength dependence, there is no need to transmit wavelength information to the optical receiver 20a side.

### Third Embodiment

In the third embodiment, a configuration will be described in which, in a communication system including an optical transceiver and an optical receiver, an optical transmitter specifies the transmission characteristics of a transmission path between the optical transceiver and the optical receiver. More specifically, in the third embodiment, the optical transceiver sweeps the wavelength of the light source and transmits an optical signal of respective wavelengths, a returning device returns (reflects) the optical signal transmitted from the optical transceiver as it is, and the optical transceiver receives the optical signal returned by the returning device, thereby specifying which wavelength is being transmitted and determining the transmission width.

FIG. 7 is a diagram showing a configuration example of a communication system 1b in the third embodiment. The communication system 1b includes an optical transceiver 15 and a returning device 18. The optical transceiver 15 and the returning device 18 are connected via a transmission path 35. Note that a plurality of optical transceivers 15 and returning devices 18 may be provided.

The optical transceiver 15 includes a wavelength sweep instruction unit 11, a light source 12, a response receiving unit 13, and a wavelength sweep identification unit 14. The optical transceiver 15 differs in configuration from the optical transmitter 10 in that it additionally includes the response receiving unit 13 and the wavelength sweep identification unit 14. The other configurations of the optical transceiver 15 (for example, the wavelength sweep instruction unit 11 and the light source 12) are the same as those of the optical transmitter 10. The optical transceiver 15 is one aspect of a first optical communication device.

The response receiving unit 13 receives the optical signal returned by the returning device 18. The response receiving unit 13 specifies the transmission width based on the received optical signal and the information held by the wavelength sweep identification unit 14.

The wavelength sweep identification unit 14 holds the swept wavelength information instructed to the light source 12 by the wavelength sweep instruction unit 11. The swept wavelength information includes at least information specifying the wavelength to be swept.

The returning device 18 includes a reflection/transmission unit 24. The returning device 18 differs in configuration from the optical receiver 20 in that it does not include the receiving unit 21 and the wavelength sweep identification unit 22, but includes the reflection/transmission unit 24. The returning device 18 is an aspect of a second optical communication device.

The reflection/transmission unit 24 switches an operation mode in response to a return instruction from another device. If there is no instruction from another device to return the optical signal, the reflection/transmission unit 24 transmits the optical signal (user signal) transmitted from the optical transceiver 15. In this case, the returning device 18 internally processes the optical signal transmitted from the optical transceiver 15 or outputs it to the outside. The other device may be the optical transceiver 15 or a management device (not shown) that performs management control (for example, wavelength allocation or the like) of the optical transceiver 15 and the returning device 18 in the communication system 1b.

When instructed by another device to return the optical signal, the reflection/transmission unit 24 returns the optical signal transmitted from the optical transceiver 15 to the optical transceiver 15 as it is. That is, the reflection/transmission unit 24 performs full-channel loopback. In other words, the reflection/transmission unit 24 returns a loopback signal to the optical transceiver 15 without changing any bits in the bit sequence of the received loopback signal. In other words, the reflection/transmission unit 24 reflects the optical signal transmitted from the optical transceiver 15. For example, the reflection/transmission unit 24 is a half mirror.

Returning the optical signal without modulation is the closest to full-channel loopback of the three loopback mechanisms for “Layer 1” maintenance in the “JT-I430” standard. The three loopback mechanisms are (1) full-channel loopback, (2) partial loopback, and (3) logical loopback. In full-channel loopback, the optical signal is returned to a transmitting station (here, the optical transceiver 15) without changing the entire bit sequence. The returning an optical signal without modulation has several differences from that of “Layer 1” of the “JT-I430” standard.

First, the returning point is not close to the “T” reference point within “NT1” but is far away. Therefore, it is not “loop 2”.

Furthermore, since there are signals (analog signals) or the like that are not treated as a bit sequence in the APN, in that case, a communication device cannot send back the bit sequence. However, even if the bit sequence cannot be sent back, if information is sent back as it is, this point (difference) can be ignored.

Furthermore, if the wavelength-dependent element and the polarization-dependent element have different reflectances, the optical signal will not be sent back without modulation.

Adding modulation, amplification, or attenuation to a part of an optical signal in at least one of the time domain and the frequency domain and returning the optical signal can be regarded as corresponding to “(2) partial loopback” or “(3) logical loopback”. In partial loopback, the received bit sequence of one or more designated channels is sent back to a transmitting station unchanged. Therefore, if the modulation frequency is regarded as a channel, partially modulating and returning the optical signal is similar to partial loopback. This is because there may be certain changes in the returned information. Further, the modulating and returning of the optical signal is similar to logical loopback.

Note that each of the three loopback mechanisms is further classified into (a) transparent loopback and (b) non-transparent loopback. This is a classification for signals that are transmitted beyond the loopback point without being returned during loopback. From this, it is possible to achieve “(a) transparent loopback” and “(b) non-transparent loopback” by reflecting a part of the optical signal and transmitting the remaining optical signal. Here, in “(a) transparent loopback”, the signal transmitted beyond the returning point (forward signal) and the received signal at the returning point are the same. In “(b) non-transparent loopback”, the signal transmitted beyond the returning point (forward signal) and the received signal at the returning point are the same. However, it is mainly assumed that the optical signal will not be transmitted. The received signal may be amplified, or modulation (on-off modulation, intensity modulation, polarization modulation, or the like) performed on the light as it is may be performed on the received signal.

The method of switching between reflecting and transmitting the optical signal transmitted from the optical transceiver 15 is not limited to a specific method. For example, by inserting or removing an optical fiber connected to the reflection/transmission unit 24, the reflection/transmission unit 24 may switch between reflecting and transmitting (on and off of the returning) an optical signal using the Fresnel reflection at the end point of the optical fiber.

FIG. 8 is a diagram showing the flow of a wavelength channel width transmission confirmation process performed by the communication system 1b in the third embodiment. Note that, in the process of FIG. 8, a case will be described in which swept wavelength information is shared between the optical transceiver 15 and the returning device 18 by exchanging messages. This is suitable for sharing swept wavelength information through message exchange and for changing the characteristics and reflection method of the reflection/transmission unit 24 (for example, a half mirror) depending on the wavelength. It is also assumed that swept wavelength information is not shared. If the swept wavelength information is not shared, the process shown in FIG. 8 is executed after the return setting is made in advance on the returning device 18 side. The process in FIG. 8 is executed, for example, at the time of initial setting when the main signal is not transmitted, or when transmission confirmation.

The optical transceiver 15 and the returning device 18 share swept wavelength information by exchanging messages (step S301). When the returning device returns the optical signal transmitted from the optical transceiver as light as in the third embodiment, a message regarding instructions for reflection is exchanged between the optical transceiver 15 and the returning device 18. Specifically, the message exchange is performed by the optical transceiver 15 transmitting a message including an instruction for causing the returning device 18 to perform reflection in advance to the returning device 18. Note that the message may include instructions regarding modulation during reflection, wavelength-dependent reflection, and the like. As described above, if the swept wavelength information is not shared, the process of step S301 may be omitted.

The wavelength sweep instruction unit 11 of the optical transceiver 15 instructs the light source 12 to sweep the wavelength channel to be confirmed. For example, the wavelength sweep instruction unit 11 instructs the light source 12 to sweep the wavelength channel along with information on the sweep width of the wavelength channel to be confirmed. Furthermore, the wavelength sweep instruction unit 11 outputs the swept wavelength information to the wavelength sweep identification unit 14. The light source 12 transmits an optical signal of respective wavelengths to the returning device 18 via the transmission path 35 while sweeping the wavelength to be confirmed based on the information on the sweep width according to the instruction from the wavelength sweep instruction unit 11 (step S302).

The reflection/transmission unit 24 of the returning device 18 returns the optical signal of respective wavelengths transmitted from the optical transceiver 15 as light (step S303). The optical signal of respective wavelengths transmitted from the optical transceiver 15 is returned to the returning device 18 by the reflection/transmission unit 24 of the returning device 18.

The response receiving unit 13 of the returning device 18 receives the optical signal of respective wavelengths returned by the returning device 18. Every time the response receiving unit 13 receives an optical signal, the response receiving unit, 13 converts the received optical signal into an electrical signal and measures the reception intensity (step S304). The response receiving unit 13 specifies the transmission width based on the measured reception intensity and the swept wavelength information output from the wavelength sweep identification unit 14 (step S305).

According to the communication system 1b configured as described above, the optical signal of respective wavelengths transmitted from the optical transceiver 15 is returned as the optical signal by the returning device 18 and received by the optical transceiver 15. In such a configuration, the product of the widths in both directions can be specified. The optical transceiver 15 specifies the transmission width based on the optical signal returned by the returning device 18 and the swept wavelength information held by itself. In this way, even if the returning device 18 is not equipped with an optical spectrum analyzer, the transmission characteristics which are characteristics related to the transmission path can be specified. Therefore, it becomes possible to easily specify the transmission characteristics which are the characteristics related to the transmission path between the optical transmitter and the optical receiver with a cheaper configuration.

### Modified Example 1 of Third Embodiment

The optical transceiver 15 may modulate and transmit an optical signal of respective wavelengths. When configured in this way, the optical transceiver 15 includes a modulation unit that modulates the optical signal. When the optical signal transmitted by the optical transceiver 15 is a modulated optical signal, the optical transceiver 15 may transmit the optical signal by sweeping the wavelength in a wavelength range with a width obtained by subtracting the modulation sideband on one side of a modulation from the width of the wavelength channel to be confirmed for transmission, as in the first embodiment. With this configuration, the sweep width can be reduced. Furthermore, when an optical signal of respective wavelengths is modulated and transmitted, messages can be exchanged. However, when exchanging messages, the width and depth of the modulation sideband change depending on the content of the message. Therefore, it is desirable to continue measurement at respective wavelengths for a time period that includes a message that can be considered random on a time average, or to transmit random data that can be considered random in addition to the message.

From the viewpoint of reducing the sweep width as described above, when the optical transceiver 15 modulates the optical signal of respective wavelengths, it is desirable to perform steep modulation or random modulation so as to have a broad frequency component. For example, this is because, when modulating with a single sine wave, there is only one modulation sideband on each side, which has only the width of the frequency fluctuation of the sine wave, so a gap is created. From the viewpoint of increasing the sensitivity of transmission in the modulation component, it is desirable that the intensity of the modulation sideband be modulated deeply. Note that it may be deep enough to eliminate non-modulated components.

### Fourth Embodiment

In the fourth embodiment, a configuration in which the configurations shown in the first to third embodiments are applied to an APN will be described. Note that, in the fourth embodiment, a user device transmits an optical signal of respective wavelengths while sweeping the wavelength of the light source, and a Ph-GW converts the optical signal of respective wavelengths into an electrical signal, measure the reception intensity of the electrical signal, and specifies which wavelength is being transmitted to specify the transmission width. In the following description, the direction from the user device to the Ph-GW will be referred to as an upstream direction, and the direction from the Ph-GW to the user device will be referred to as a downstream direction. In the fourth embodiment, the transmission width in the upstream direction is specified.

### Basic Configuration Example of APN

Since APN uses a flat architecture, there is no need for the electrical termination of optical signals that was provided between layers in communication networks compared to APN. APN has very low latency due to its end-to-end optical path connection. In addition, APN has high flexibility and expandability, allowing it to easily provide a high-capacity, low-latency communication network for each function without relying on a specific communication protocol.

APN includes two types of optical nodes: photonic gateways (Ph-GW) and photonic exchanges (hereinafter referred to as “Ph-EX”), as optical nodes which minimize electrical processing such as exchange, multiplexing, and switching. Ph-GW is connected to full mesh. Ph-GW is an optical node located at the entrance of a full-mesh network and accommodates various user devices. Ph-EX is an optical node that provides a huge number of optical paths. Full mesh is a connection form in which all elements constituting a communication network are directly connected to each other. Ph-EX is an optical node that provides a huge number of optical paths. These huge number of optical paths transparently traverse the optical backbone network.

With such a configuration, the APN can directly connect installation points of arbitrary user devices by optical signals without performing electrical processing. By allocating dedicated wavelengths to user services, it becomes possible to realize high-capacity, low-latency communications. The APN can provide a variety of services by flexibly combining the necessary service function processes at the required points. Furthermore, the APN can provide a communication environment that does not require consideration of service types, protocols, optical wavelengths, or the like.

In order to achieve end-to-end optical direct connection and service function processing at required points, Ph-GW has the five basic functions illustrated below.

The first basic function is to determine which wavelength the user device uses and to remotely set wavelength information on the user device. In order to open an end-to-end optical path, the Ph-GW is required to have a function of allocating wavelengths to each optical path so that wavelengths of optical signals do not overlap between optical paths that share a transmission medium (such as an optical fiber) within an APN. Furthermore, the Ph-GW is required to have a function of remotely setting the wavelength information of the optical signal of the user device, which is the end point of the optical path.

The second basic function is to stop unnecessary signals caused by incorrect wavelength information settings in user devices or the like by communicating optical signals between the access network-side port and the full-mesh network-side port when the optical path is opened Here, the access network is a network between Ph-GW and user device, and the full-mesh network is a network between Ph-GWs or a network consisting of Ph-GW and Ph-EX. Depending on the destination, Ph-GW transmits (cross-connects) optical signals input from the access network to the access network, optical signals input from the access network to the full-mesh network, optical signals input from the full-mesh network to the access network, and optical signals input from the mesh network to the full-mesh network as optical signals.

The third basic function is to aggregate and disaggregate optical paths that share a transmission medium within a full-mesh network.

The fourth basic function is a turn-back function for directly optically connecting user devices accommodated in the same Ph-GW. By enabling turn-back at the Ph-GW located at the entrance of the full-mesh network, rather than turn-back at the upper optical node, direct optical connection is achieved through the shortest path.

The fifth basic function is a removal and insertion function. The removal and insertion function enables electrical processing at the Ph-GW location in order to perform regenerative relay of optical signals in terms of optical signal transmission and to perform service function processing.

### Outline of APN

FIG. 9 is a diagram showing a configuration example of a communication system la that communicates using a communication network such as an all photonics network (APN). In the communication system la, a device at one end of a determination target section transmits an optical signal, the user device at the other end performs optical-electrical-optical conversion (OEO conversion) and returns the optical signal, thereby determining the normality of the optical signal path in the determination target section.

The communication system 1c includes a Ph-GW 100-1, a Ph-GW 100-2, an APN controller 200, a user device 300-1, and a user device 300-2. Note that, in order to simplify the explanation, in FIG. 9, two Ph-GWs and two user devices are shown. In an actual communication system, a large number of Ph-GWs and user devices are arranged, and Ph-EX may be disposed between the Ph-GWs, and the user device may be connected to only a single Ph-GW.

Since the Ph-GW 100 transmits and receives optical signals in order to determine the normality of the section between the user device and another Ph-GW 100 and to monitor and control the user device, the Ph-GW 100 includes a device (transmitting/receiving device) that transmits and receives optical signals. Note that, if the position of the Ph-GW 100 is not at the end point of the section, the optical signal may be transmitted.

Further, the Ph-GW 100 is a device (cross-connect device) that cross-connects optical signals to destinations. The Ph-GW 100-1 includes an optical cross-connect unit 101-1, a wavelength multiplexing/demultiplexing unit 102-1, and an access network management control unit 103-1. The Ph-GW 100-2 includes an optical cross-connect unit 101-2, a wavelength multiplexing/demultiplexing unit 102-2, and an access network management control unit 103-2. The optical cross-connect unit 101 includes a plurality of input/output ports (not shown). Note that the wavelength multiplexing/demultiplexing unit 102 may not be provided on the path of a target optical signal.

The optical cross-connect unit 101-1 and the optical cross-connect unit 101-2 transmit (cross-connect) optical signals input from the access network and the full-mesh network as they are, depending on the destination. In this way, the optical cross-connect unit 101-1 and the optical cross-connect unit 101-2 realize the returning function for direct optical connection (the fourth basic function described above).

The optical cross-connect unit 101-1 and the optical cross-connect unit 101-2 realize a returning function (the fourth basic function described above) for directly optically connecting the user devices 300 accommodated in the same Ph-GW 100. Furthermore, the optical cross-connect unit 101-1 and the optical cross-connect unit 101-2 realize the optical add/drop function (the fifth basic function described above) of adding or dropping optical signals to or from an electrical processing unit (not shown).

The wavelength multiplexing/demultiplexing unit 102-1 wavelength-multiplexes optical signals having the same destination among the optical signals output from the optical cross-connect unit 101-1. The wavelength multiplexing/demultiplexing unit 102-1 outputs the wavelength-multiplexed optical signal to the full-mesh network. The wavelength multiplexing/demultiplexing unit 102-1 separates the wavelength-multiplexed signal input from the full-mesh network in units of wavelengths.

The wavelength multiplexing/demultiplexing unit 102-2 wavelength-multiplexes optical signals having the same destination among the optical signals output from the optical cross-connect unit 101-2. The wavelength multiplexing/demultiplexing unit 102-2 outputs the wavelength-multiplexed optical signal to the full-mesh network. The wavelength multiplexing/demultiplexing unit 102-2 separates the wavelength-multiplexed signal input from the full-mesh network in units of wavelengths (the third basic function described above).

The access network management control unit 103-1 exchanges control information between the access network management control unit 103-1 and the user device 300-1 at the time of initial connection of the user device 300-1. The access network management control unit 103-1 transmits a wavelength setting instruction to the user device 300-1.

The access network management control unit 103-2 exchanges control information between the access network management control unit 103-2 and the user device 300-2 at the time of initial connection of the user device 300-2. The access network management control unit 103-2 transmits a wavelength setting instruction to the user device 300-2 (the first basic function described above).

Optical signals transmitted and received by the access network management control unit 103 (hereinafter referred to as “access network optical signals”) may be demultiplexed onto the path to the user device 300 at any point. For example, the access network optical signals may be demultiplexed in wavelength multiplexing/demultiplexing unit 102, the access network optical signals may be demultiplexed between the wavelength multiplexing/demultiplexing unit 102 and the optical cross-connect unit 101, the access network optical signal may be demultiplexed in the optical cross-connect unit 101, or the access network optical signal may be demultiplexed between the optical cross-connect unit 101 and the user device 300.

Instead of multiplexing the access network optical signal with the main optical signal by space division multiplexing, polarization division multiplexing, wavelength division multiplexing, or the like, the access network management control unit 103 may multiplex a control signal on the main optical signal in the form of frequency division multiplexing such as time division multiplexing, code division multiplexing, or AMCC, or may multiplex a control signal onto the main optical signal by modulating it in the form of intensity modulation, phase modulation, frequency modulation, or polarization modulation. In this case, instead of multiplexing using a coupler/splitter, multiplexer/demultiplexer, or the like, multiplexing may be performed using a modulator or an amplifier or attenuator that can modulate the amplification factor or attenuation factor. In the following, the case where a control signal is multiplexed onto the main optical signal will be mainly described, but it is clear that it can also be used when multiplexing an access network optical signal that is different from the main optical signal. Note that, if the access network optical signal is multiplexed on the loopback side and the optical transmitters and the optical receivers for the access network optical signal and the main signal are separate, since the optical transmitter and the optical receiver for the main signal are excluded from the normality determination, it is desirable to perform a loopback between the optical transmitter and the optical receiver or to confirm the normality by means other than the loopback in order to confirm the normality of the section excluded from the normality determination. In addition, by using these methods, if the loopback signal is looped back from the optical transmitter of the access network optical signal only when the normality of the optical transmitter and optical receiver of the main signal is confirmed, it is possible to notify the normality of the optical transmitter and optical receiver of the main signal with a single loopback. Naturally, the normality of the optical transmitter and optical receiver for the main signal and the normality of the optical transmitter and optical receiver for the access network optical signal may be determined and notified separately.

The access network optical signal may be multiplexed onto the path to the user device 300 at any point. For example, the access network optical signals may be multiplexed in the wavelength multiplexing/demultiplexing unit 102, the access network optical signals may be multiplexed between the wavelength multiplexing/demultiplexing unit 102 and the optical cross-connect unit 101, the access network optical signals may be multiplexed in the optical cross-connect unit 101, or the access network optical signals may be multiplexed between the optical cross-connect unit 101 and the user device 300.

APNs that support a variety of social infrastructure networks are required to be able to set up optical paths for a variety of user devices so that dedicated networks with wavelengths for different functions can be easily provided. Therefore, a mechanism is required in which an optical path is immediately opened just by connecting the user device 300-1 and user device 300-2 to an optical fiber.

First, the user device 300-1 and user device 300-2 report their subject device information and opposing device information to the Ph-GW 100-1 and the Ph-GW 100-2. The user device 300-1 or the user device 300-2 may report its subject device information and opposing device information to the Ph-GW 100-1 or Ph-GW 100-2.

Although the information is reported to the closest Ph-GW 100, it may be reported to a Ph-GW 100 other than the closest Ph-GW. For example, the user device 300-1 or user device 300-2 may report its subject device information and opposing device information to the Ph-GW 100-2 or the Ph-GW 100-1. The latter is suitable when, for example, the information on the Ph-GW to which the opposite device is connected is known when restoring a connection. Below, the case where the information is reported to the closest Ph-GW will be mainly explained.

Second, the APN controller 200 performs wavelength resource management and optical path design within the APN. In response to the report from the user device 300-1 or user device 300-2, the Ph-GW 100-1 or Ph-GW 100-2 cooperates with the APN controller 200 to determine the wavelength allocation to the user device 300-1 and user device 300-2. The Ph-GW 100-1 or Ph-GW 100-2 notifies the user device 300-1 or user device 300-2 of the wavelength.

Third, an internal path of the Ph-GW 100-1, an internal path of the Ph-GW 100-2, and an internal path of the Ph-EX are set. In FIG. 9, an internal path of the Ph-GW 100-1, an internal path of the Ph-GW 100-2, and a path connecting the Ph-GW 100-1 and Ph-GW 100-2 are set. When the Ph-GW 100-1 and Ph-GW 100-2 are connected via Ph-EX (not shown), the internal path of the Ph-GW 100-1, the path of the Ph-GW 100-1 and Ph-EX (not shown), the internal path of the Ph-EX (not shown), and the path of the Ph-EX (not shown) and Ph-GW 100-2 and the internal route of the Ph-GW 100-2 are set.

In the APN, optical signals according to signals of various communication protocols are transmitted from the user device 300-1 and user device 300-2. Therefore, a management control method that does not depend on communication protocols is required. For example, AMCC is used for such access system control management.

Furthermore, the communication system 1c includes the following configuration in order to specify transmission characteristics that are characteristics related to the transmission path between the optical transmitter and the optical receiver. The optical transmitter includes a wavelength-tunable transmitting unit capable of transmitting at least an optical signal of a wavelength channel for which the transmission characteristics are to be confirmed. The optical receiver includes a wavelength-independent optical receiving unit. Here, the optical transmitter may be the user device 300 in the communication system 1c, or may be the Ph-GW 100. The optical receiver is the Ph-GW 100 when the optical transmitter is the user device 300, and is the user device 300 when the optical transmitter is the Ph-GW 100.

FIG. 10 is a diagram showing a configuration example (part 1) of a communication system 1c in the fourth embodiment. Among the devices included in the communication system 1c, FIG. 10 shows only the devices related to one section that is the target of signal path normality determination and the target of transmission width confirmation. In the fourth embodiment, the access network management control unit 103 performs signal path normality determination for the user device 300 connected to its subject device (Ph-GW 100). For example, the access network management control unit 103-2 in FIG. 9 performs signal path normality determination on the user device 300-2. As for the correspondence between FIG. 9 and FIG. 10, it is assumed that a transmission path 35 shown in FIG. 10 represents only a transmission path when the access network management control unit 103 is located closer to the user device 300 than the optical cross-connect unit 101, and the transmission path 35 includes the transmission path and the optical cross-connect unit 101 when the optical cross-connect unit 101 is located closer to the user device 300 than the access network management control unit 103.

That is, as shown in FIG. 10 and FIGS. 13, 14, 15, 16, and 17 described later, a configuration in which the access network management control unit 103 includes a multiplexing/demultiplexing unit that demultiplexes and superimposes a control signal on a main signal can also be considered as follows. For example, a transmitter is disposed at a position at which it is possible to output an optical signal toward a device (for example, the user device 300) that returns an optical signal via an optical coupler/splitter or optical multiplexer/demultiplexer installed outside the input port or output port of the optical cross-connect unit 101. For example, a transmitter is disposed in a monitoring unit that monitors the optical intensity of an optical signal on at least one of the input side and output side of the Ph-GW 100 and exchanges control signals with the user device 300. Instead of outputting combined or multiplexed light through an optical coupler/splitter or an optical multiplexer/demultiplexer, the generated light may be output by an optical nonlinear effect of the returned light.

For example, a receiver is disposed at a position at which an optical signal returned from an optical signal returning device or at least a part of its components can be input via an optical coupler/splitter or an optical multiplexer/demultiplexer installed outside the input port or output port of the optical cross-connect unit 101. For example, a receiver is disposed in a monitoring unit that monitors the optical intensity of an optical signal on at least one of the input side and output side of the Ph-GW 100 and exchanges control signals with the user device 300. Instead of inputting split or demultiplexed light through an optical coupler/splitter or an optical multiplexer/demultiplexer, the generated light may be input by an optical nonlinear effect of the returned light.

As shown in FIG. 12, a configuration in which the access network management control unit 103 does not include a multiplexing/demultiplexing unit that demultiplexes and superimposes a control signal on a main signal can also be considered as follows. For example, if a transmitter that transmits an optical signal that is returned by the opposing device is disposed in the Ph-GW 100, the transmitter is disposed in the access network management control unit 103 connected via the optical cross-connect unit 101. For example, if a receiver that receives at least a part of the optical signal returned by the opposing device is disposed in the Ph-GW 100, the receiver is disposed in a location other than the access network management control unit 103 connected via the optical cross-connect unit 101.

Furthermore, in the fourth embodiment, processing for specifying the transmission characteristics of the transmission path 35 between the Ph-GW 100 including the access network management control unit 103 and the user device 300 (wavelength channel width transmission confirmation process) is also performed. In the communication system 1c according to the fourth embodiment, a case will be described in which the user device 300 has the configuration of the optical transmitter 10, and the Ph-GW 100 including the access network management control unit 103 has the configuration of the optical receiver 20. That is, in the communication system 1c in the fourth embodiment, the user device 300 transmits an optical signal of respective wavelengths while sweeping the wavelength of the light source, and the Ph-GW 100 including the access network management control unit 103 converts the optical signal of respective wavelengths into an electrical signal, measures the reception intensity of the electrical signal, and specifies which wavelength is being transmitted to specify transmission width.

The access network management control unit 103 transmits a control signal for instructing loopback to the user device 300 (target user device) connected to the target section of signal path normality determination. In the loopback in the fourth embodiment, the normality of the path between UNI_PHY and MAC is not determined. The control signal used is a control signal used in common by a plurality of user devices 300 (which may be all user devices 300 of the communication system 1). A specific example of such a control signal is, for example, AMCC. In order to realize such processing, the access network management control unit 103 includes a determination control unit 401, an optical interface unit (optical IF unit) 405, an optical interface unit (optical IF unit) 406, a multiplexing/demultiplexing unit 407, and a multiplexing/demultiplexing unit 408.

The determination control unit 401 performs a signal path normality determination process. The determination control unit 401 is configured using one or more processors such as a central processing unit (CPU) and one or more memories. The determination control unit 401 functions when one or more processors execute a program. All or part of the functions of the determination control unit 401 may be realized using hardware such as an application specific integrated circuit (ASIC), a programmable logic device (PLD), or a field programmable gate array (FPGA). The above-mentioned program may be recorded on a computer-readable recording medium. Computer-readable recording media include portable media such as flexible disks, magneto-optical disks, read only memory (ROMs), compact disc read only memory (CD-ROMs), or semiconductor storage devices (SSDs: solid state drives) and storage devices such as hard disks or semiconductor storage devices built into computer system. The above-mentioned program may be transmitted via a telecommunication line.

The determination control unit 401 outputs a control signal indicating execution of loopback to the optical interface unit 405. The control signal used is a signal that can be used in common by a plurality of user devices 300. The control signal output by the determination control unit 401 is an electrical signal. Upon receiving the control signal looped back from the user device 300, the determination control unit 401 determines the normality of the determination target path based on the received signal. For example, the determination control unit 401 receives a control signal looped back from the user device 300 via the multiplexing/demultiplexing unit 408 and the optical interface unit 406. In this way, the determination control unit 401 outputs a control signal that is an electrical signal to the optical interface unit 405, and obtains the control signal converted into an electrical signal from the optical interface unit 406.

The optical interface unit 405 converts the control signal, which is an electrical signal output from the determination control unit 401, into an optical signal. The optical interface unit 405 outputs the converted optical signal to the multiplexing/demultiplexing unit 407.

The multiplexing/demultiplexing unit 407 receives, as input, the optical signal output from the optical interface unit 405 and the main signal addressed to the user device 300 (hereinafter referred to as “downstream main signal”). The multiplexing/demultiplexing unit 407 superimposes the optical signal on the input downstream main signal. For example, the multiplexing/demultiplexing unit 407 may frequency-superimpose the optical signal on the main signal. Note that FIG. 10 shows a configuration in which a control signal separate from the downstream main signal is superimposed, but when modulating by a nonlinear optical effect or the like, frequency superimposition may be applied to the configuration shown in FIG. 10. Further, the configuration for frequency superimposition using a modulator or the like will be specifically explained with reference to FIG. 13.

The multiplexing/demultiplexing unit 408 separates or splits the signals received from the user device 300. For example, if the control signal and the upstream main signal can be separated by wavelength separation or the like, the multiplexing/demultiplexing unit 408 separates the signal received from the user device 300 into the control signal and the upstream main signal. The upstream main signal is a main signal transmitted from the user device 300 in the upstream direction (for example, to the opposing user device). In this case, the multiplexing/demultiplexing unit 408 outputs the separated control signals to the optical interface unit 406. The multiplexing/demultiplexing unit 408 outputs the separated upstream main signals to other devices.

Further, for example, when control signals such as AMCC are frequency-superimposed, the multiplexing/demultiplexing unit 408 splits the signal (upstream main signal including the control signal) received from the user device 300. In this case, the multiplexing/demultiplexing unit 408 outputs the split signal (upstream main signal including the control signal) to the optical interface unit 406 and other devices.

The optical interface unit 406 acquires the optical signal output from the multiplexing/demultiplexing unit 408. The optical signal acquired by the optical interface unit 406 is a control signal separated by the multiplexing/demultiplexing unit 408, or an upstream main signal including a split control signal. The optical interface unit 406 converts the obtained optical signal into an electrical signal. The optical interface unit 406 outputs the electrical signal obtained by the conversion to the determination control unit 401.

Further, the optical interface unit 406 includes the receiving unit 21 and the wavelength sweep identification unit 22 in the first embodiment, and performs the same processing as the optical receiver 20 in the first embodiment.

The user device 300 includes an optical transceiver 301 and a control unit 330. The optical transceiver 301 includes an optical interface unit 321 (optical IF unit), a multiplexing/demultiplexing unit 322, a processing unit 323, a UNI_PHY(Tx) 324, a UNI_PHY(Rx) 325, and an optical interface unit 326 (optical IF unit)).

The optical interface unit 321 converts the optical signal received from the Ph-GW 100 into an electrical signal. The optical interface unit 321 outputs the electrical signal obtained by the conversion to the multiplexing/demultiplexing unit 322.

The multiplexing/demultiplexing unit 322 separates the signal received from the Ph-GW 100 into a control signal and a downstream main signal. The multiplexing/demultiplexing unit 322 outputs the separated control signals to the control unit 330. The multiplexing/demultiplexing unit 322 outputs the separated downstream main signals to the processing unit 323. The multiplexing/demultiplexing unit 322 superimposes the control signal output from the control unit 330 on the upstream main signal output from the processing unit 323. For example, the multiplexing/demultiplexing unit 322 may frequency-superimpose the control signal on the upstream main signal.

When the processing unit 323 is a MAC, the processing unit 323 executes media access control on the downstream main signal output from the multiplexing/demultiplexing unit 322. For example, the processing unit 323 defines and allocates an address (MAC address) for identifying a device. For example, the processing unit 323 may control the signal transmission timing. The processing unit 323 outputs the main signal to the UNI_PHY(Tx) 324. The processing unit 323 may perform media access control on the electrical signal output from the UNI_PHY(Rx) 325. The processing unit 323 outputs the main signal to the multiplexing/demultiplexing unit 322.

The UNI_PHY(Tx) 324 is a reception function unit in the physical layer of a user network interface. The UNI_PHY(Tx) 324 performs predetermined reception processing on the electrical signal output from the processing unit 323.

The UNI_PHY(Rx) 325 is a transmission function unit in the physical layer of the user network interface. The UNI_PHY(Rx) 325 outputs an electrical signal according to the main signal to the processing unit 323 by executing predetermined transmission processing.

The optical interface unit 326 converts the electrical signals (for example, upstream main signal and control signal) output from the multiplexing/demultiplexing unit 322 into optical signals. Note that the optical interface unit 326 may output the control signal and the upstream main signal using different light sources, different wavelengths, or different polarizations. The optical interface unit 326 transmits the optical signal obtained by the conversion to the Ph-GW 100. Furthermore, the optical interface unit 326 includes the light source 12 in the first embodiment, and transmits an optical signal of respective wavelengths included in the sweep width instructed by the wavelength sweep instruction unit 11 included in the control unit 330 in a predetermined order.

The control unit 330 is configured using one or more processors such as a CPU and one or more memories. The control unit 330 functions as at least a control signal receiving unit 331, a control signal transmitting unit 332, a returning unit 333, and the wavelength sweep instruction unit 11 when one or more processors execute a program. All or part of the functions of the control unit 330 may be realized using hardware such as ASIC, PLD, or FPGA. The above-mentioned program may be recorded on a computer-readable recording medium. Computer-readable recording media include portable media such as flexible disks, magneto-optical disks, ROMs, CD-ROMs, semiconductor storage devices (for example, SSDs), and storage devices such as hard disks and semiconductor storage devices built into computer systems. The above-mentioned program may be transmitted via a telecommunication line.

The control signal receiving unit 331 receives the control signals separated by the multiplexing/demultiplexing unit 322 from the multiplexing/demultiplexing unit 322. The control signal receiving unit 331 operates according to information indicated by the received control signal. If the control signal is information indicating an instruction to execute loopback, the control signal receiving unit 331 instructs the returning unit 333 to execute loopback in accordance with the instruction.

The control signal transmitting unit 332 outputs a transmission target control signal to the multiplexing/demultiplexing unit 322.

When receiving an instruction to perform loopback from the control signal receiving unit 331, the returning unit 333 executes loopback processing in accordance with the instruction. The target of loopback processing in the returning unit 333 is, for example, a control signal. The loopback processing may be implemented as a full-channel loopback, a partial loopback, or a logical loopback, for example. The looped-back control signal is converted into an optical signal by the optical interface unit 326 and transmitted to the access network management control unit 103.

The wavelength sweep instruction unit 11 performs the same processing as the wavelength sweep instruction unit 11 in the first embodiment. Specifically, the wavelength sweep instruction unit 11 instructs the light source 12 provided in the optical interface unit 326 to sweep the wavelength channel to be confirmed for transmission. The wavelength sweep instruction unit 11 may instruct the light source 12 at any timing during initial settings, or may instruct the light source 12 at the timing when a control signal transmitted from the access network management control unit 103 is received.

The flow of the signal path normality determination process in the fourth embodiment will be described. At a predetermined timing, the determination control unit 401 generates a control signal for instructing execution of loopback. The determination control unit 401 outputs the generated control signal to the optical interface unit 405. The predetermined timing may be, for example, the timing at which a problem in communication with the user device 300 is detected. The optical interface unit 405 converts the control signal output from the determination control unit 401 into an optical signal and outputs it to the multiplexing/demultiplexing unit 407. A downstream main signal transmitted from another device and an optical signal output from the optical interface unit 405 are input to the multiplexing/demultiplexing unit 407. The multiplexing/demultiplexing unit 407 multiplexes the input downstream main signal and the optical signal (for example, superimposes the optical signal on the downstream main signal), and transmits the multiplexed optical signal to the user device 300 via the transmission path.

Upon receiving the multiplexed optical signal from the access network management control unit 103, the optical interface unit 321 of the user device 300 converts the received multiplexed optical signal into an electrical signal and outputs the electrical signal to the multiplexing/demultiplexing unit 322. The multiplexing/demultiplexing unit 322 separates the received signal into a downstream main signal and a control signal. The multiplexing/demultiplexing unit 322 outputs the separated control signal to the control unit 330 and outputs the separated downstream main signal to the processing unit 323.

When the control signal receiving unit 331 of the control unit 330 receives the control signal from the multiplexing/demultiplexing unit 322, it operates according to the content of the control included in the control signal. The control signal includes a signal indicating an instruction to perform loopback. In response to this instruction, the control signal receiving unit 331 instructs the returning unit 333 to execute loopback of the control signal. The returning unit 333 performs loopback processing on the received control signal and outputs the control signal to the multiplexing/demultiplexing unit 322. The multiplexing/demultiplexing unit 322 combines the control signal output from the control unit 330 and the upstream main signal output from the processing unit 323. The control signal and upstream main signal multiplexed by the multiplexing/demultiplexing unit 322 are looped back to the access network management control unit 103.

The looped-back upstream main signal and control signal are separated in the multiplexing/demultiplexing unit 408. For example, the multiplexing/demultiplexing unit 408 separates the upstream main signal and the control signal. The control signal separated in the multiplexing/demultiplexing unit 408 is converted into an electrical signal in the optical interface unit 406, and is input to the determination control unit 401, which is the source of the control signal. The determination control unit 401 performs a predetermined evaluation on the input control signal according to the transmission confirmation. For example, an evaluation may be made regarding whether loopback was performed correctly. The determination control unit 401 performs a signal path normality determination regarding the target user device based on the evaluation result. The determination control unit 401 may output the determination result to another device or record it in a storage device as a log.

Note that, in the communication system 1c in the fourth embodiment, the wavelength channel width transmission confirmation process may be performed offline at the time of initial setting, as in the first embodiment. Alternatively, the communication system 1c in the fourth embodiment may execute the wavelength channel width transmission confirmation process at the same timing as the signal path normality determination process or at the timing when the signal path normality determination process is completed. The wavelength channel width transmission confirmation process is the same as in the first embodiment.

FIG. 11 is a diagram for supplementary explanation of the configuration when AMCC is used as in the communication system 1c in the fourth embodiment. The modulation sideband of AMCC has a narrower spectrum width than the modulation sideband of the main signal, which has a higher modulation rate. For example, even the first stage is a passband, and the main signal during modulation of the second stage is partially not passed due to bandwidth limitation, it will be passed if the main signal is unmodulated and only AMCC is modulated. Therefore, even if a signal is modulated with only AMCC having a narrow modulation sideband, the main signal with a broader modulation sideband is simulated by varying the wavelength, thereby reducing the effect of bandwidth limitation. Even if the modulation of the main signal has stopped and there is a wavelength shift of the optical transmitter or the effect of the bandwidth limitation of the transmission path 35, it is possible to confirm whether the main signal can be passed by transmission confirmation of the AMCC.

According to the communication system 1c in the fourth embodiment configured as described above, the same effects as in the first embodiment can be obtained in the APN as well.

### Modified Example 1 of Fourth Embodiment

In the embodiment described above, an example is shown in which the user device 300 has a configuration corresponding to the optical transmitter 10 in the first embodiment, and the access network management control unit 103 has a configuration corresponding to the optical receiver 20 in the first embodiment. In the communication system 1c in the fourth embodiment, the user device 300 may have a configuration corresponding to the optical transmitter 10a in the second embodiment or the optical transceiver 15 in the third embodiment, and the access network management control unit 103 may have a configuration corresponding to the optical receiver 20a in the second embodiment or the returning device 18 in the third embodiment.

For example, when the user device 300 has the configuration of the optical transmitter 10a in the second embodiment, the wavelength sweep instruction unit 11 is provided in the control unit 330, the light source 12 is provided in the optical interface unit 326, and the response receiving unit 13 is provided in the optical interface unit 321. When the access network management control unit 103 has the configuration of the optical receiver 20a in the second embodiment, the receiving unit 21 is provided in the optical interface unit 406, and the response unit 23 is provided in the optical interface unit 405. The specific processing is the same as in the second embodiment.

For example, when the user device 300 has the configuration of the optical transceiver 15 in the third embodiment, the wavelength sweep instruction unit 11 is provided in the control unit 330, the light source 12 is provided in the optical interface unit 326, and the response receiving unit 13 and the wavelength sweep identification unit 14 are provided in the optical interface unit 321. When the access network management control unit 103 has the configuration of the returning device 18 in the third embodiment, the reflection/transmission unit 24 is located before the optical interface unit 405 and the optical interface unit 406 (closer to the transmission path 35 than the optical interface unit 405 and the optical interface unit 406), transmits an optical signal of a specific wavelength, and returns an optical signal of a swept wavelength. The specific processing is the same as in the third embodiment.

### Modified Example 2 of Fourth Embodiment

In the embodiment described above, the user device 300 specifies the transmission width by transmitting an optical signal of respective wavelengths while sweeping the wavelength of the light source. In the communication system 1c in the fourth embodiment, the access network management control unit 103 may also have a configuration for transmitting an optical signal of respective wavelengths while sweeping the wavelength of the light source, and may be configured to specify the transmission width in both directions. Although an example using the configuration of the first embodiment will be described below, the configurations of the second and third embodiments may also be used.

When configured in this way, the access network management control unit 103 further includes the wavelength sweep instruction unit 11, and the optical interface unit 405 further includes the light source 12 in the first embodiment. The light source 12 of the optical interface unit 405 sequentially transmits an optical signal of respective wavelengths included in the sweep width instructed by the wavelength sweep instruction unit 11.

The optical interface unit 321 included in the optical transceiver 301 of the user device 300 further includes the receiving unit 21 and the wavelength sweep identification unit 22 in the first embodiment, and performs the same processing as the optical receiver 20 in the first embodiment.

### Modified Example 4 of Fourth Embodiment

The access network management control unit 103 shown in FIG. 10 may be configured as shown in FIG. 12. FIG. 12 is a diagram showing a configuration example (part 2) of the communication system 1c in the fourth embodiment. Among the devices included in the communication system 1c, FIG. 12 shows only the devices related to one section that is the target of signal path normality determination and the target of transmission width confirmation. As for the correspondence between FIG. 9 and FIG. 12, it is assumed that a transmission path 35 shown in FIG. 12 represents only a transmission path when the access network management control unit 103 is located closer to the user device 300 than the optical cross-connect unit 101, and the transmission path 35 includes the transmission path and the optical cross-connect unit 101 when the optical cross-connect unit 101 is located closer to the user device 300 than the access network management control unit 103.

The access network management control unit 103 shown in FIG. 12 includes a determination control unit 401, an optical interface unit (optical IF unit) 405, and an optical interface unit (optical IF unit) 406. The access network management control unit 103 shown in FIG. 12 differs in configuration from the access network management control unit 103 shown in FIG. 10 in that it does not include the multiplexing/demultiplexing unit 407 and the multiplexing/demultiplexing unit 408. The differences from the access network management control unit 103 shown in FIG. 10 will be explained below.

The optical interface unit 405 converts a control signal (denoted as a downstream control signal in FIG. 12), which is an electrical signal output from the determination control unit 401, into an optical signal. The optical interface unit 405 transmits the converted optical signal to the user device 300 via the transmission path 35.

The optical interface unit 406 receives the optical signal transmitted from the user device 300 via the transmission path 35. The optical signal received by the optical interface unit 406 is an upstream control signal. The optical interface unit 406 converts the received optical signal into an electrical signal. The optical interface unit 406 outputs the electrical signal obtained by the conversion to the determination control unit 401.

Further, the optical interface unit 406 includes the receiving unit 21 and the wavelength sweep identification unit 22 in the first embodiment, and performs the same processing as the optical receiver 20 in the first embodiment.

In this way, the access network management control unit 103 shown in FIG. 12 does not transmit and receive main signals, but only transmits and receives control signals. Note that the user device 300 shown in FIG. 12 performs the same process as the user device 300 shown in FIG. 10 except for the process using the upstream main signal and the downstream main signal in the process explained in FIG. 10.

FIG. 10 shows a configuration in which the control signal is multiplexed with the main signal. However, the configuration shown in FIG. 12 corresponds to a configuration in which the optical cross-connect unit 101 switches to input and output upstream and downstream control signals instead of upstream and downstream main signals.

### Modified Example 5 of Fourth Embodiment

The access network management control unit 103 shown in FIG. 10 may be configured as shown in FIG. 13. FIG. 13 is a diagram showing a configuration example (part 3) of the communication system 1c in the fourth embodiment. Among the devices included in the communication system 1c, FIG. 13 shows only the devices related to one section that is the target of signal path normality determination and the target of transmission width confirmation. As for the correspondence between FIG. 9 and FIG. 13, it is assumed that a transmission path 35 shown in FIG. 13 represents only a transmission path when the access network management control unit 103 is located closer to the user device 300 than the optical cross-connect unit 101, and the transmission path 35 includes the transmission path and the optical cross-connect unit 101 when the optical cross-connect unit 101 is located closer to the user device 300 than the access network management control unit 103.

The access network management control unit 103 shown in FIG. 13 includes a determination control unit 401, a modulation unit 409, and a monitor unit 410. The access network management control unit 103 shown in FIG. 13 differs in configuration from the access network management control unit 103 shown in FIG. 10 in that it does not include an optical interface unit 405, an optical interface unit 406, a multiplexing/demultiplexing unit 407, and a multiplexing/demultiplexing unit 408, but is newly provided with a modulation unit 409 and a monitor unit 410. The differences from the access network management control unit 103 shown in FIG. 10 will be explained below. The configuration shown in FIG. 13 assumes that the access network management control unit 103 performs in-channel monitoring.

The modulation unit 409 receives the control signal output from the determination control unit 401 and the downstream main signal input from an external device as input. The modulation unit 409 modulates the input downstream main signal with a control signal to generate an optical modulation signal. The modulation unit 409 transmits the optical modulation signal to the user device 300 via the transmission path 35.

The monitor unit 410 monitors the signals (upstream main signal and control signal) received from the user device 300 and outputs them to the determination control unit 401 and other devices. More specifically, the monitor unit 410 has the same functions as the multiplexing/demultiplexing unit 408 and the optical interface unit 406, and receives signals (upstream main signal and control signal) transmitted from the user device 300. The monitor unit 410 splits the received signal, converts the upstream main signal including the split control signal into an electrical signal, and outputs the electrical signal to the determination control unit 401. Note that the access network management control unit 103 may further include the receiving unit 21 and the wavelength sweep identification unit 22 in the first embodiment, and perform the same processing as the optical receiver 20 in the first embodiment based on the optical signal transmitted from the user device 300. The receiving unit 21 and the wavelength sweep identification unit 22 may be provided inside the monitor unit 410 or may be provided outside the monitor unit 410 as long as they are located at a position where the optical signal transmitted from the user device 300 can be acquired after being converted into an electrical signal. Furthermore, the monitor unit 410 outputs the upstream main signal including the split control signal to an external device as an optical signal.

The operations performed by user device 300 are similar to those of user device 300 shown in FIG. 10.

### Modified Example 6 of Fourth Embodiment

The access network management control unit 103 shown in FIG. 10 may be configured as shown in FIG. 14. FIG. 14 is a diagram showing a configuration example (part 4) of the communication system 1c in the fourth embodiment. Among the devices included in the communication system 1c, FIG. 14 only shows devices related to one section that is the target of signal path normality determination and the target of transmission width confirmation. As for the correspondence between FIG. 9 and FIG. 14, it is assumed that a transmission path 35 shown in FIG. 14 represents only a transmission path when the access network management control unit 103 is located closer to the user device 300 than the optical cross-connect unit 101, and the transmission path 35 includes the transmission path and the optical cross-connect unit 101 when the optical cross-connect unit 101 is located closer to the user device 300 than the access network management control unit 103.

The access network management control unit 103 shown in FIG. 14 includes a determination control unit 401, an optical interface unit 406, a multiplexing/demultiplexing unit 408, and a modulation unit 409. The access network management control unit 103 shown in FIG. 14 differs in configuration from the access network management control unit 103 shown in FIG. 10 in that it does not include the optical interface unit 405, the optical interface unit 406, and the multiplexing/demultiplexing unit 407 but is newly provided with a modulation unit 409. The differences from the access network management control unit 103 shown in FIG. 10 will be explained below.

The modulation unit 409 receives the control signal output from the determination control unit 401 and the downstream main signal input from an external device as input. The modulation unit 409 modulates the input downstream main signal with a control signal to generate an optical modulation signal. The modulation unit 409 transmits the optical modulation signal to the user device 300 via the transmission path 35.

The multiplexing/demultiplexing unit 408 and the optical interface unit 406 perform the same processing as the multiplexing/demultiplexing unit 408 and the optical interface unit 406 shown in FIG. 10.

### Modified Example 7 of Fourth Embodiment

In the above-described embodiment and Modified Examples 1 to 6, a configuration is shown in which the AMCC signal is looped back to determine the normality of the signal path. The access network management control unit 103 may be configured to loop back the main signal at the user device 300 to determine the normality of the signal path. FIG. 15 is a diagram showing a configuration example of a communication system 1c in Modified Example 7 of the fourth embodiment. Among the devices included in the communication system 1c, FIG. 15 shows only the devices related to one section that is the target of signal path normality determination and the target of transmission width confirmation. In the fourth embodiment, the access network management control unit 103 performs signal path normality determination for the user device 300 connected to its subject device (Ph-GW 100). For example, the access network management control unit 103-2 in FIG. 9 performs a signal path normality determination on the user device 300-2. As for the correspondence between FIG. 9 and FIG. 15, it is assumed that a transmission path 35 shown in FIG. 15 represents only a transmission path when the access network management control unit 103 is located closer to the user device 300 than the optical cross-connect unit 101, and the transmission path 35 includes the transmission path and the optical cross-connect unit 101 when the optical cross-connect unit 101 is located closer to the user device 300 than the access network management control unit 103.

When looping back the main signal at the user device 300, unlike the content described in FIG. 10, the main signal is looped back to the access network management control unit 103 via the processing unit 323, UNI_PHY(Tx) 324, and UNI_PHY(Rx) 325. More specifically, the multiplexing/demultiplexing unit 322 separates the control signal from the signal received from the Ph-GW 100 and outputs the separated control signal to the control unit 330. The control signal includes, for example, information indicating an instruction to loop back the main signal. The multiplexing/demultiplexing unit 322 outputs a signal (main signal) in which the control signal is separated to the processing unit 323. The control unit 330 instructs the optical transceiver 301 to loop back the main signal based on the control signal. Further, the wavelength sweep instruction unit 11 of the control unit 330 instructs the optical transceiver 301 to perform a wavelength channel width transmission confirmation process during loopback.

The optical transceiver 301 transmits the main signal output from the multiplexing/demultiplexing unit 322 according to instructions from the control unit 330 to the access network management control unit 103 via the processing unit 323, UNI_PHY(Tx) 324, UNI_PHY(Rx) 325, multiplexing/demultiplexing unit 322, and optical interface unit 326.

Further, the optical interface unit 326 of the optical transceiver 301 transmits an optical signal of respective wavelengths while sweeping the wavelength of the light source according to instructions from the control unit 330.

The main signal looped back in the user device 300 is input to the access network management control unit 103. Note that the configuration of the access network management control unit 103 is basically the same as the configuration shown in FIG. 10. The access network management control unit 103 shown in FIG. 15 differs from the access network management control unit 103 shown in FIG. 10 in that the main signal separated in the multiplexing/demultiplexing unit 408 is input to the optical interface unit 406. Thereafter, the optical interface unit 406 converts the main signal separated by the multiplexing/demultiplexing unit 408 into an electrical signal and outputs it to the determination control unit 401. The determination control unit 401 performs a predetermined evaluation on the input main signal according to the transmission confirmation. For example, an evaluation may be made regarding whether loopback was performed correctly. The determination control unit 401 performs a signal path normality determination regarding the target user device based on the evaluation result. The determination control unit 401 may output the determination result to another device or record it in a storage device as a log. Note that when the main signal is looped back by the user device 300, the access network management control unit 103 shown in FIG. 15 may have the same configuration as the access network management control unit 103 shown in FIG. 13.

Furthermore, the optical interface unit 406 of the access network management control unit 103 converts the optical signal of respective wavelengths transmitted from the user device 300 into an electrical signal, measures the reception intensity of the electrical signal, and specifies which wavelength is being transmitted to specify the transmission width.

### Fifth Embodiment

In the fifth embodiment, a configuration in which the configurations shown in the first to third embodiments are applied to an APN will be described. In the fifth embodiment, the Ph-GW transmits an optical signal of respective wavelengths while sweeping the wavelength of the light source, and the user device converts the optical signal of respective wavelengths into an electrical signal, measures the reception intensity of the electrical signal, and specifies which wavelength is being transmitted to specify the transmission width. In the fifth embodiment, the transmission width in the downstream direction is specified.

FIG. 16 is a diagram showing a configuration example of a communication system 1c in the fifth embodiment. Among the devices included in the communication system 1c, FIG. 16 shows only the devices related to one section that is the target of signal path normality determination and the target of transmission width confirmation. In the fifth embodiment, the access network management control unit 103 performs signal path normality determination for the user device 300 connected to its subject device (Ph-GW 100). For example, the access network management control unit 103-2 in FIG. 9 performs a signal path normality determination on the user device 300-2. As for the correspondence between FIG. 9 and FIG. 16, it is assumed that a transmission path 35 shown in FIG. 16 represents only a transmission path when the access network management control unit 103 is located closer to the user device 300 than the optical cross-connect unit 101, and the transmission path 35 includes the transmission path and the optical cross-connect unit 101 when the optical cross-connect unit 101 is located closer to the user device 300 than the access network management control unit 103.

Furthermore, in the fifth embodiment, the access network management control unit 103 also performs processing for specifying the transmission characteristics of the transmission path 35 between the Ph-GW 100 including the access network management control unit 103 and the user device 300 (wavelength channel width transmission confirmation processing). In the communication system 1c in the fifth embodiment, a case will be described in which the Ph-GW 100 including the access network management control unit 103 has the configuration of the optical transmitter 10, and the user device 300 has the configuration of the optical receiver 20. That is, in the communication system 1c in the fifth embodiment, the Ph-GW 100 including the access network management control unit 103 transmits an optical signal of respective wavelengths while sweeping the wavelength of the light source, and the user device 300 converts the optical signal of respective wavelengths into an electrical signal, measures the reception intensity of the electrical signal, and specifies which wavelength is being transmitted to specify the transmission width. Hereinafter, differences from the fourth embodiment will be explained.

The access network management control unit 103 includes a determination control unit 401, an optical interface unit (optical IF unit) 405, an optical interface unit (optical IF unit) 406, a multiplexing/demultiplexing unit 407, a multiplexing/demultiplexing unit 408, and a wavelength sweep instruction unit 11.

The wavelength sweep instruction unit 11 performs the same processing as the wavelength sweep instruction unit 11 in the first embodiment. Specifically, the wavelength sweep instruction unit 11 instructs the light source 12 provided in the optical interface unit 405 to sweep the wavelength channel to be confirmed for transmission. The wavelength sweep instruction unit 11 may instruct the light source 12 at any timing during initial setting, or may instruct the light source 12 at the timing when the access network management control unit 103 transmits a control signal.

The optical interface unit 405 converts the control signal output from the determination control unit 401 into an optical signal. The optical interface unit 405 outputs the converted optical signal to the multiplexing/demultiplexing unit 407. Further, the optical interface unit 405 includes the light source 12 in the first embodiment, and sequentially transmits an optical signal of respective wavelengths included in the sweep width instructed by the wavelength sweep instruction unit 11.

The multiplexing/demultiplexing unit 407 receives the optical signal output from the optical interface unit 405 and the downstream main signal as input. The multiplexing/demultiplexing unit 407 superimposes the optical signal on the input downstream main signal. For example, the multiplexing/demultiplexing unit 407 may frequency-superimpose the optical signal on the main signal.

The multiplexing/demultiplexing unit 408 separates or splits the signals received from the user device 300. For example, if the control signal and the upstream main signal can be separated by wavelength separation or the like, the multiplexing/demultiplexing unit 408 separates the signal received from the user device 300 into the control signal and the upstream main signal. The upstream main signal is a main signal transmitted from the user device 300 in the upstream direction (for example, to the opposing user device). In this case, the multiplexing/demultiplexing unit 408 outputs the separated control signals to the optical interface unit 406. The multiplexing/demultiplexing unit 408 outputs the separated upstream main signals to other devices.

Further, for example, when control signals such as AMCC are frequency-superimposed, the multiplexing/demultiplexing unit 408 splits the signal (upstream main signal including the control signal) received from the user device 300. In this case, the multiplexing/demultiplexing unit 408 outputs the split signal (upstream main signal including the control signal) to the optical interface unit 406 and other devices.

The optical interface unit 406 acquires the optical signal output from the multiplexing/demultiplexing unit 408. The optical signal acquired by the optical interface unit 406 is a control signal separated by the multiplexing/demultiplexing unit 408, or an upstream main signal including a split control signal. The optical interface unit 406 converts the obtained optical signal into an electrical signal. The optical interface unit 406 outputs the electrical signal obtained by the conversion to the determination control unit 401.

The user device 300 includes an optical transceiver 301 and a control unit 330. The optical interface unit 321 included in the optical transceiver 301 further includes the receiving unit 21 and wavelength sweep identification unit 22 in the first embodiment, and performs the same processing as the optical receiver 20 in the first embodiment.

Note that, in the communication system 1c in the fifth embodiment, the wavelength channel width transmission confirmation process may be performed offline at the time of initial setting, as in the first embodiment. Alternatively, the communication system 1c in the fifth embodiment may execute the wavelength channel width transmission confirmation process at the same timing as the signal path normality determination process or at the timing when the signal path normality determination process is completed. The wavelength channel width transmission confirmation process is the same as in the first embodiment.

According to the communication system 1c in the fifth embodiment configured as described above, the same effects as in the first embodiment can be obtained in the APN as well.

### Modified Example 1 of Fifth Embodiment

In the embodiment described above, an example is shown in which the access network management control unit 103 has a configuration corresponding to the optical transmitter 10 in the first embodiment, and the user device 300 has a configuration corresponding to the optical receiver 20 in the first embodiment. In the communication system 1c in the fifth embodiment, the access network management control unit 103 may have a configuration corresponding to the optical transmitter 10a in the second embodiment or the optical transceiver 15 in the third embodiment, and the user device 300 may have a configuration corresponding to the optical receiver 20a in the second embodiment or the returning device 18 in the third embodiment.

For example, when the access network management control unit 103 has the configuration of the optical transmitter 10a in the second embodiment, the light source 12 is provided in the optical interface unit 405, and the response receiving unit 13 is provided in the optical interface unit 406. When the user device 300 has the configuration of the optical receiver 20a in the second embodiment, the receiving unit 21 is provided in the optical interface unit 321, and the response unit 23 is provided in the optical interface unit 326. The specific processing is the same as in the second embodiment.

For example, when the access network management control unit 103 has the configuration of the optical transceiver 15 in the third embodiment, the light source 12 is provided in the optical interface unit 405, and the response receiving unit 13 and the wavelength sweep identification unit 14 are provided in the optical interface unit 406. When the user device 300 has the configuration of the returning device 18 in the third embodiment, the reflection/transmission unit 24 is located before the optical interface unit 321 and the optical interface unit 326 (closer to the transmission path 35 than the optical interface unit 321 and the optical interface unit 326), transmits an optical signal of a specific wavelength, and returns an optical signal of a swept wavelength. The specific processing is the same as in the third embodiment.

### Modified Example 2 of Fifth Embodiment

In the embodiment described above, the access network management control unit 103 specifies the transmission width by transmitting an optical signal of respective wavelengths while sweeping the wavelength of the light source. In the communication system 1c in the fifth embodiment, the user device 300 may also have a configuration for transmitting an optical signal of respective wavelengths while sweeping the wavelength of the light source, and may be configured to specify the transmission width in both directions. Although an example using the configuration of the first embodiment will be described below, the configurations of the second and third embodiments may also be used.

When configured in this way, the control unit 330 of the user device 300 further includes the wavelength sweep instruction unit 11, and the optical interface unit 326 further includes the light source 12 in the first embodiment. The light source 12 of the optical interface unit 326 sequentially transmits an optical signal of respective wavelengths included in the sweep width instructed by the wavelength sweep instruction unit 11.

The optical interface unit 406 included in the access network management control unit 103 further includes the receiving unit 21 and wavelength sweep identification unit 22 in the first embodiment, and performs the same processing as the optical receiver 20 in the first embodiment.

### Modified Example 4 of Fifth Embodiment

The access network management control unit 103 shown in FIG. 16 may not include the multiplexing/demultiplexing unit 407 and the multiplexing/demultiplexing unit 408. When configured in this way, the access network management control unit 103 shown in FIG. 16 has a configuration in which the access network management control unit 103 shown in FIG. 12 is additionally provided with the wavelength sweep instruction unit 11. Hereinafter, the differences from the access network management control unit 103 shown in FIG. 12 will be explained.

The optical interface unit 405 converts the control signal, which is an electrical signal output from the determination control unit 401, into an optical signal. The optical interface unit 405 transmits the converted optical signal to the user device 300 via the transmission path 35. Further, the optical interface unit 405 includes the light source 12 in the first embodiment, and sequentially transmits an optical signal of respective wavelengths included in the sweep width instructed by the wavelength sweep instruction unit 11.

### Modified Example 5 of Fifth Embodiment

In the embodiment described above, a configuration is shown in which the AMCC signal is looped back to determine the normality of the signal path. The access network management control unit 103 may be configured to loop back the main signal at the user device 300 to determine the normality of the signal path, as shown in Modified Example 7 of the fourth embodiment. The process of looping back the main signal at the user device 300 and determining the normality of the signal path is similar to the process shown in Modified Example 7 of the fourth embodiment.

### Modified Example 6 of Fifth Embodiment

The configuration for performing signal loopback in the user device 300 may be the configuration shown in FIG. 17. FIG. 17 is a diagram showing a configuration example of a communication system 1c in Modified Example 6 of the fifth embodiment. As for the correspondence between FIG. 9 and FIG. 17, it is assumed that a transmission path 35 shown in FIG. 17 represents only a transmission path when the access network management control unit 103 is located closer to the user device 300 than the optical cross-connect unit 101, and the transmission path 35 includes the transmission path and the optical cross-connect unit 101 when the optical cross-connect unit 101 is located closer to the user device 300 than the access network management control unit 103.

In the communication system 1c in Modified Example 6 of the fifth embodiment, the Ph-GW 100 (access network management control unit 103 in FIG. 17) transmits an optical signal of respective wavelengths while sweeping the wavelength of the light source, the user device 300 returns (reflects) the optical signal transmitted from the access network management control unit 103 as it is, and the access network management control unit 103 receives the optical signal returned to the user device 300, thereby specifying which wavelength is transmitted to specify the transmission width.

The processing performed by the access network management control unit 103 to both sweep the wavelength of the light source and specify the transmission width is similar to the processing performed by the communication system 1b in the third embodiment shown in FIG. 7. In this case, the access network management control unit 103 includes the configuration of the wavelength sweep instruction unit 11, the light source 12, the response receiving unit 13, and the wavelength sweep identification unit 14, and the user device 300 includes the configuration of the reflection/transmission unit 24. This will be explained in detail below.

The user device 300 includes an optical transceiver 301, a control unit 330, and a reflection/transmission unit 350. The user device 300 shown in FIG. 17 differs the processing of the control unit 330 and in configuration from the user device 300 shown in FIG. 16 in that the reflection/transmission unit 350 is newly provided. The differences will be explained below. Note that the user device 300 includes a reflection/transmission unit 350 on the side of the user device 300 closer to the APN (Ph-GW). The user device 300 may include a reflection/transmission unit 350 in the optical IF unit (for example, the optical interface unit 321).

Upon receiving the return instruction from the access network management control unit 103, the reflection/transmission unit 350 outputs the return instruction to the control unit 330. The reflection/transmission unit 350 switches the operation mode according to the control of the control unit 330. The operation mode is, for example, a reflection mode and a transmission mode. The reflection mode is a mode in which the optical signal input to the reflection/transmission unit 350 is not transmitted through the reflection/transmission unit 350 and is returned as it is. The transmission mode is a mode in which the reflection/transmission unit 350 operates to transmit or partially transmit the optical signal input thereto. If the return instruction does not include an instruction to return the optical signal, that is, if there is no instruction from the access network management control unit 103 (instruction device) to return the optical signal, the reflection/transmission unit 350 operates in the transmission mode and transmits the optical signal (user signal) transmitted from the Ph-GW 100 and output it to the optical interface unit 321.

If the return instruction includes an instruction to return the optical signal, that is, if the access network management control unit 103 instructs to return the optical signal, the reflection/transmission unit 350 operates in the reflection mode and returns the optical signal transmitted from the Ph-GW 100 or the opposing user device as it is to the Ph-GW 100 according to the period during which normality is confirmed without photoelectrically converting the optical signal. That is, the reflection/transmission unit 350 executes full-channel loopback. In other words, the reflection/transmission unit 350 (loopback point) returns the loopback signal to the Ph-GW 100 (transmitting/receiving device) without changing any bit in the bit sequence of the received loopback signal. In other words, the reflection/transmission unit 350 reflects the optical signal transmitted from the Ph-GW 100. In FIG. 17, the arrow returning from the network side to the network side via the reflection/transmission unit 350 represents the return of the optical signal.

The control unit 330 does not include a control signal receiving unit 331, a control signal transmitting unit 332, and a returning unit 333, but includes a switching control unit 334. The switching control unit 334 obtains a return instruction from the reflection/transmission unit 350. The switching control unit 334 controls switching of the operation mode of the reflection/transmission unit 350 in accordance with the acquired return instruction. For example, if the return instruction includes an instruction to return the optical signal, the switching control unit 334 controls the reflection/transmission unit 350 to return the optical signal. For example, if the return instruction does not include an instruction to return the optical signal, the switching control unit 334 controls the reflection/transmission unit 350 to transmit the optical signal. Through such processing, the reflection/transmission unit 350 can realize the returning of the optical signal and the transmission of the optical signal.

The processing of each functional unit included in the optical transceiver 301 described below is the processing performed while the reflection/transmission unit 350 is transmitting or partially transmitting an optical signal.

The optical interface unit 321 (optical IF unit) converts the optical signal transmitted through the reflection/transmission unit 350 into an electrical signal. In this way, photoelectric conversion may be performed inside the user device 300. The optical signal transmitted through the reflection/transmission unit 350 may be an optical signal of a main signal (user signal) or an optical signal of a loopback signal. The optical interface unit 321 outputs an electrical signal corresponding to the optical signal transmitted through the reflection/transmission unit 350 to the multiplexing/demultiplexing unit 322. Here, even if OE conversion is performed, the remaining optical signal excluding the portion to be OE-converted is not OEO-converted and is returned. In normal loopback, signals from users are not transmitted to the network side during loopback. Further, signals from the network are not transmitted to the user side. Therefore, the following explanation of transmitting a signal from a user device to the network and transmitting a signal from the network to the user side is an explanation of the operation in the case where no loopback is performed. Depending on the method of loopback, a half mirror or the like may be used to transmit the signal even during loopback.

The multiplexing/demultiplexing unit 322 separates the optical signal output from the optical interface unit 321 into the main signal (user signal) and control signal. The multiplexing/demultiplexing unit 322 outputs the main signal in the optical signal output from the optical interface unit 321 to the processing unit 323.

The multiplexing/demultiplexing unit 322 multiplexes the control signal onto the main signal (user signal) in the electrical signal output from the processing unit 323. For example, if the control signal is an AMCC signal, the multiplexing/demultiplexing unit 322 frequency-superimposes the control signal on the main signal. The multiplexing/demultiplexing unit 322 outputs an electrical signal including the main signal and the control signal to the optical interface unit 326.

The processing unit 323 is, for example, a regenerative repeater, and includes a reshaping function, a retiming function, and an identification and regenerating function. For example, there is a multiplexing unit and a separating unit. For example, it is a conversion unit that converts a signal from a user NW into a signal format transmitted by APN. For example, it is a framer that demultiplexes signals from a user NW into transmission frames. The processing unit 323 is, for example, a MAC, and executes media access control. For example, a MAC may perform such media access control when transmitting and receiving user signals that define and allocate addresses (MAC addresses) for identifying devices. For example, the MAC may control the transmission timing of optical signals. The MAC performs media access control on the optical signal output from the multiplexing/demultiplexing unit 322. The MAC receives signals from the user, sends signals to the user, receives signals from the network, and sends signals to the network according to media access control. During loopback, the process of the user device not allowing signals to be communicated from the user side to the network side and from the network side to the user side may be performed using media access control. The MAC may execute media access control so that the signal from the UNI_PHY(Tx) 324 is not output from the network side to the user side, and the signal from the UNI_PHY(Rx) 325 is not output from the user side to the network side.

Note that the configurations of the multiplexing/demultiplexing unit and the processing unit do not need to be limited to those described above. For example, the multiplexing/demultiplexing unit may be disposed closer to the network than the optical IF unit and the optical IF unit. In this case, the multiplexing/demultiplexing unit performs AMCC superimposition and demultiplexing on the optical signal. Furthermore, when control signals are exchanged using OTN frames, GCC, or the like, the multiplexing/demultiplexing unit and the processing unit may function as an OTN framer.

The UNI_PHY(Tx) 324 is a reception function unit in the physical layer of the user network interface. The UNI_PHY(Rx) 325 performs predetermined reception processing on the electrical signal (main signal) output from the processing unit 323. A receiver (Rx) on the user side receives a signal from the user side, and a receiver (Rx) on the network side receives a signal from the network side.

The UNI_PHY(Rx) 325 is a transmission function unit in the physical layer of the user network interface. The UNI_PHY(Tx) 324 outputs an electrical signal according to the main signal (user signal) to the processing unit 323 by executing predetermined transmission processing. A transmitter (Tx) on the user side transmits a signal to the user side. A transmitter (Tx) on the network side transmits a signal to the network side.

The optical interface unit 326 (optical IF unit) on the transmitting side converts the electrical signal output from the multiplexing/demultiplexing unit 322 into an optical signal. In this way, inside the optical transceiver 301, a process of converting an electrical signal into an optical signal may be executed. The optical interface unit 326 outputs the converted optical signal to the reflection/transmission unit 350. The optical interface unit 326 on the receiving side converts the optical signal into an electrical signal. Note that, if the optical signal is not looped back, the optical interface unit performs OE conversion or electrical-optical (EO) conversion. If the reflection/transmission unit 350 does not transmit the optical signal, the optical interface unit performs OE conversion or EO conversion during loopback. In addition, when the optical signal from the network is returned, part of it is split and received, and some of the optical signals are multiplexed on the returned optical signal, the optical interface unit performs OE conversion or EO conversion at the time of loopback. The UNI_PHY(Rx) 325 receives signals from the user side. The received signal is output to the network side via the device. The received signal may be terminated within the device. The UNI_PHY(Tx) 324 outputs a signal from the network side or a signal from inside the device to the user side. The UNI_PHY(Rx) 325 side of the optical interface unit receives signals from the network. The received signal is output to the user side via the device. The received signal may be terminated within the device. The UNI_PHY(Tx) 324 side of the optical interface unit outputs a signal from the user side or a signal from inside the device to the network side. Note that the receiver (Rx) on the user side and the receiver (Rx) on the network side are not shown.

The access network management control unit 103 includes a determination control unit 401, an optical interface unit (optical IF unit) 405, an optical interface unit (optical IF unit) 406, a multiplexing/demultiplexing unit 407, a multiplexing/demultiplexing unit 408, and a wavelength sweep instruction unit 11.

The wavelength sweep instruction unit 11 performs the same processing as the wavelength sweep instruction unit 11 in the first embodiment. Specifically, the wavelength sweep instruction unit 11 instructs the light source 12 provided in the optical interface unit 405 to sweep the wavelength channel to be confirmed for transmission. The wavelength sweep instruction unit 11 may instruct the light source 12 at any timing during initial setting, or may instruct the light source 12 at the timing when the access network management control unit 103 transmits a control signal.

The optical interface unit 405 converts the control signal output from the determination control unit 401 into an optical signal. The optical interface unit 405 outputs the converted optical signal to the multiplexing/demultiplexing unit 407. Further, the optical interface unit 405 includes the light source 12 in the first embodiment, and sequentially transmits an optical signal of respective wavelengths included in the sweep width instructed by the wavelength sweep instruction unit 11.

The optical interface unit 406 acquires the optical signal output from the multiplexing/demultiplexing unit 408. The optical interface unit 406 converts the obtained optical signal into an electrical signal. The optical interface unit 406 outputs the electrical signal obtained by the conversion to the determination control unit 401.

Further, the optical interface unit 406 includes the response receiving unit 13 and the wavelength sweep identification unit 14 in the third embodiment, and performs the same processing as the optical transceiver 15 in the third embodiment. For example, the response receiving unit 13 receives the control signals separated by the multiplexing/demultiplexing unit 408. The response receiving unit 13 specifies the transmission width based on the received control signal (optical signal) and information held by the wavelength sweep identification unit 14.

The access network management control unit 103 shown in FIG. 17 may not include the multiplexing/demultiplexing unit 407 and the multiplexing/demultiplexing unit 408 as shown in FIG. 12. In this configuration, the optical interface unit 405 of the access network management control unit 103 converts the control signal, which is an electrical signal output from the determination control unit 401, into an optical signal, and transmits the converted optical signal to the user device 300 via the transmission path 35. The optical signal is reflected by the reflection/transmission unit 350 of the user device 300 and received by the optical interface unit 406 of the access network management control unit 103. The optical interface unit 406 specifies the transmission width based on the received control signal (optical signal) and information held by the wavelength sweep identification unit 14.

The access network management control unit 103 shown in FIG. 17 may loop back the main signal at the user device 300 as shown in FIG. 15, and specify the transmission width based on the looped-back optical signal.

Although FIG. 17 shows a configuration in which the reflection/transmission unit 350 is included in the user device 300, the reflection/transmission unit 350 may be included in the Ph-GW 100. When the Ph-GW 100 is provided with the reflection/transmission unit 350, the reflection/transmission unit 350 may use the returning function of the fourth function of the Ph-GW 100.

### Sixth Embodiment

In the sixth embodiment, a configuration in which the configurations shown in the first to third embodiments are applied to a WDM-passive optical network (WDM-PON) will be described. Specifically, in the sixth embodiment, in a communication system in which an optical line terminal (OLT) and one or more optical network units (ONUs) are connected via a WDM coupler such as an arrayed waveguide grating (AWG) that multiplexes and demultiplexes optical signals, the transmission width of the WDM coupler is specified.

FIG. 18 is a diagram showing a configuration example of a communication system 1d in the sixth embodiment. The communication system 1d includes an OLT 510, one or more ONUs 520, and a WDM coupler 530. Connections are made between the OLT 510 and the WDM coupler 530, and between one or more ONUs 520 and the WDM coupler 530 via optical fibers.

The OLT 510 is an optical line termination device installed at the station side. The OLT 510 has, for example, the configuration of either the optical transmitter 10 or 10a or the optical transceiver 15, and performs the same processing as the optical transmitter 10 or 10a or the optical transceiver 15 of the first to third embodiments.

The ONU 520 is an optical subscriber line termination device installed on the customer side. The ONU 520 has, for example, the configuration of any one of the optical receivers 20, 20a, and 20b, and performs the same processing as any of the optical receivers 20, 20a, and 20b of the first to third embodiments.

The WDM coupler 530 is a device such as an arrayed waveguide grating (AWG) that multiplexes and demultiplexes optical signals.

In the case of WDM-PON, which uses the same path for round trips, it is easy to estimate the one-way characteristics because the path with the same characteristics is passed twice. For example, if it can be approximated by a Gaussian, the characteristics with the index halved can be estimated to be the one-way characteristics.

According to the communication system 1d in the sixth embodiment configured as described above, the same effects as any of the first to fourth embodiments can be obtained also in WDM-PON.

### Hardware Configuration Example

FIG. 19 is a diagram showing a hardware configuration example of the communication systems 1a, 1b, 1c, and 1d in the embodiments. Some or all of the functional units of the communication systems 1a, 1b, 1c, and 1d are realized as software when one or more processors 201 such as a CPU executes a program stored in a storage device 203 and a memory 202 having a non-volatile recording medium (non-transitory recording medium).

The program may be recorded on a computer-readable non-transitory recording medium. A computer-readable non-transitory recording medium is, for example, a non-transitory recording medium such as a portable medium such as a flexible disk, a magneto-optical disk, a ROM, or a CD-ROM, or a storage device such as a hard disk built into a computer system. A communication unit 204 executes predetermined communication processing. The communication unit 204 may acquire data of an optical signal transmitted through an optical fiber (for example, main signal data, wavelength data) and a program.

Some or all of the functional units of the communication systems 1a, 1b, 1c, and 1d may also be realized using hardware including electronic circuits or circuitry using, for example, large-scale integrated circuit (LSI), ASIC, PLD, or FPGA.

Although the example of the present invention has been described in detail with reference to the drawings, a specific configuration is not limited to this example, and design within the scope of the gist of the present invention, and the like are included.

### INDUSTRIAL APPLICABILITY

The present invention is applicable to optical communication systems such as all photonics networks (APN).

### REFERENCE SIGNS LIST

1, 1a, 1b, 1c, 1d Communication system
10, 10a Optical transmitter
11 Wavelength sweep instruction unit
12 Light source
13 Response receiving unit
14 Wavelength sweep identification unit
15 Optical transceiver
18 Returning device
20, 20a, 20b Optical receiver
21 Receiving unit
22 Wavelength sweep identification unit
23 Response unit
24, 350 Reflection/transmission unit
100 Ph-GW
101 Optical cross-connect unit
102 Wavelength multiplexing/demultiplexing unit
103 Access network management control unit
200 APN controller
201 Processor
202 Memory
203 Storage device
204 Communication unit
300 User device
301 Optical transceiver
321, 326 Optical interface unit (optical IF unit)
322, 407, 408 Multiplexing/demultiplexing unit
323 Processing unit
324 UNI_PHY(Tx)
325 UNI_PHY(Rx)
330 Control unit
331 Control signal receiving unit
332 Control signal transmitting unit
333 Returning unit
401 Determination control unit
404 Multiplexing/demultiplexing unit
405, 406 Optical interface unit (optical IF unit)
409 Modulation unit
410 Monitor unit
510 OLT
520 ONU
530 WDM coupler

1. A communication system comprising:
one or more first optical communication devices;
a second optical communication device configured to communicate with the one or more first optical communication devices; and
a transmission path configured to connect the one or more first optical communication devices and the second optical communication device, wherein
the one or more first optical communication devices include:
a transmitter configured to transmit an optical signal having a wavelength within a wavelength range for confirmation transmission characteristics in the optical transmission path to the second optical communication device via the optical transmission path, the communication system including:
a specifier configured to specify the transmission characteristics in the optical transmission path based on an optical signal having a wavelength within the wavelength range transmitted from the one or more first optical communication devices.

2. The communication system according to claim 1, wherein
the second optical communication device includes:
the specifier; and
a wavelength sweep identifier configured to share and hold information on an optical signal of respective wavelengths with the one or more first optical communication devices in advance, and
the specifier specifies the transmission characteristics in the transmission path using the optical signal of respective wavelengths transmitted from the one or more first optical communication devices and the information on the optical signal of respective wavelengths held by the wavelength sweep identifier.

3. The communication system according to claim 1, wherein
the one or more first optical communication devices further include:
the specifier,
the second optical communication device includes:
a receiver configured to receive the optical signal of respective wavelengths transmitted from the one or more first optical communication devices and converts the optical signal into an electrical signal; and
a responder configured to send information on a reception intensity of the electrical signal or a notification of whether reception is possible according to the reception intensity of the electrical signal to the one or more first optical communication devices as a response, and
the specifier specifies the transmission characteristics in the optical transmission path based on the response transmitted from the second optical communication device.

4. The communication system according to claim 1, wherein
the one or more first optical communication devices further include:
the specifier,
the second optical communication device includes:
a returner configured to return the optical signal of respective wavelengths transmitted from the one or more first optical communication devices as it is to the one or more first optical communication devices, and
the specifier specifies the transmission characteristics in the optical transmission path based on an optical signal returned from the second optical communication device.

5. The communication system according to claim 1, wherein
when the optical signal of respective wavelengths is modulated and transmitted, each transmitter of the one or more first optical communication devices transmits the optical signal of respective wavelengths by sweeping the wavelength in a wavelength range with a width obtained by subtracting a modulation sideband on one side of a modulation from a predetermined wavelength sweeping range.

6. The communication system according to claim 1, further comprising:
a determination controller configured to determine whether a signal path including a signal path between the one or more first optical communication devices and the second optical communication device and a signal path inside the device is normal, wherein
the one or more first optical communication devices transmit the optical signal of respective wavelengths to the second optical communication device via the optical transmission path by sweeping the wavelength at the same time as processing of determining whether the signal path is normal or after the processing.

7. A first optical communication device in a communication system comprising:
the first optical communication device;
a second optical communication device configured to communicate with the first optical communication device; and
an optical transmission path configured to connect the first optical communication device and the second optical communication device, the first optical communication device comprising:
a transmitter configured to transmit a wavelength-swept optical signal to the second optical communication device via the optical transmission path; and
a specifier configured to receive either a reception result of the wavelength-swept optical signal or an optical signal returned from the second optical communication device and specifies transmission characteristics in the optical transmission path.

8. A transmission path characteristics specifying method executed by a communication system comprising:
one or more first optical communication devices;
a second optical communication device configured to communicate with the one or more first optical communication devices; and
a transmission path configured to connect the one or more first optical communication devices and the second optical communication device, the method comprising:
allowing the one or more first optical communication devices to transmit an optical signal having a wavelength within a wavelength range for confirming transmission characteristics in the optical transmission path to the second optical communication device via the optical transmission path; and
allowing a specifier to specify the transmission characteristics in the optical transmission path based on an optical signal having a wavelength within the wavelength range transmitted from the one or more first optical communication devices.
